(19) United States
(12) Patent Application Publication
(10) Pub. No.: US 2019/0053476 A1
(43) Pub. Date: Feb. 21, 2019

(54) Clam harvester

(71) Applicant: Terrance Russell Bertoson, Peoria, AZ (US)

(72) Inventor: Terrance Russell Bertoson, Peoria, AZ (US)

(21) Appl. No.: 15/998,598

(22) Filed: Aug. 16, 2018

Related U.S. Application Data
(60) Provisional application No. 62/546,431, filed on Aug. 16, 2017.

(51) Int. Cl. A01K 80/00; A01K 74/00

(52) U.S. Cl. CPC A01K 80/00; A01K 74/00

(57) ABSTRACT

Provided are methods and apparatuses for harvesting clams, particularly soft shelled clams. The scoop is particularly configured for digging at sufficient depths into the substrate beneath the clams positions and for shooting jets of water and combinations of water and air to fluidize the surrounding substrate and float the clams to the surface for collection and transfer to a work platform. The structure and active elements of the scoop, as part of an overall harvesting platform or vehicle, which can be precisely controlled, allow for the harvesting or transplanting of soft shell clams without excessively damaging the desired shellfish.

### CROSS-REFERENCE TO RELATED APPLICATION

This application claims priority to U.S. Provisional Application No. 62/546,431, filed on Aug. 16, 2017, titled “CLAM HARVESTER”, which is herein incorporated by reference.

### FIELD

The invention pertains to mechanical clam harvesting. More specifically, the mechanical harvesting of soft shell clams, such as razor clams.

### BACKGROUND

Traditional approaches to harvesting clams in large quantities have traditionally been for the harvesting of hard shell clams. Such standard techniques include sleds with a containment nets, directly collecting with an inclined conveyor belt, and high pressure fluid jets. These traditional approaches may be suitable for some hard shell clams that can withstand such mechanical forces and retain their integrity, but these approaches as implemented to date are largely unworkable for soft shell clams, as the process of collection causes too much damage to soft shell clams.

### BRIEF SUMMARY

In some embodiments, the present disclosure is directed to a method of harvesting soft-shelled clams that can include: moving a scoop from a first position to a second position, where moving the scoop from the first position to the second position inserts the scoop into a substrate, where the substrate contains one or more clams, and where the scoop is pivotally mounted to a front of a frame; spraying water into the substrate using a plurality of water jets, where the scoop includes a first set of water ports on a surface of the scoop, where a portion of the plurality of water jets spray water into the substrate through the first set of water ports while the scoop is underneath the substrate, and where spraying the water loosens the substrate; driving the scoop through the loosened substrate, such that the one or more clams in the loosened substrate enter a catchment area behind the scoop; and transporting the one or more clams from the catchment area to a collection area mounted to the frame, where the one or more clams are transported using a conveyer belt. In various aspects, the water can be driven through the plurality of water jets by one or more of a water pump, a recycling water pump, pressurized air, or a combination thereof. In some aspects, the scoop can further include a second set of water ports along a leading edge of the scoop, where a portion of the plurality of water jets spray water through the second set of water ports from the leading edge of the scoop, thereby aiding the scoop in entering the sand when the scoop is inserted into the substrate. In some aspects, the first set of jets can be driven by a first pump and the second set of jets can be driven by a second pump. In other aspects, the first set of jets and the second set of jets are driven by the same pump. In further aspects, the leading edge of the scoop includes teeth.

In some implementations, the method can further include, with a scoop is mounted to the frame using one or more hydraulic arms, operating such that when the scoop is in the first position, the scoop is out of the substrate, and when the scoop is in the second position, the scoop is underneath the substrate. In some aspects, a mount point of the scoop can be raised or lowered to raise or lower a height of the scoop. In other aspects, the scoop is moved from the first position to the second position using a motor. In further aspects, the scoop can be inserted up to three feet deep into the substrate. In some aspects, moving the scoop includes moving the frame and the scoop in a forward direction.

In some implementations, the method can further include separating loosened substrate and the one or more clams in the catchment area using a second set of water jets. In some aspects, the catchment area can include a grate through which the loosened substrate can flow. In other aspects, the collection area includes a clam sorter configured to sort clams by size.

In some implementations, the method can further include sorting, using a clam sorter, one or more clams by size, where the clam sorter deposits clams less than or equal to a threshold size in a first container, and where the clam sorter deposits clams greater than the threshold size in a second container. In some aspects, the collection area includes a storage container for storing the one or more clams.

In some implementations, the method can further include storing a set of clams from the one or more clams in a storage container and securing the storage container to an anchor, where the anchor maintains a position of the storage container, and where the position is submerged. In such aspects, when the frame moves the anchor can remain stationary.

In some implementations, the method can further include returning a set of clams from the one or more clams to the substrate, where returning the set of clams includes using a chute mounted to the frame.

In some implementations, the frame can include vertical support members and a platform mounted on top of the vertical support members, where the collection area is on the platform. In some aspects, the frame includes wheels. In other aspects, the frame includes a motor configured drive the wheels. In further aspects, one or more wheels include a motor. In some aspects, the frame includes treads. In other aspects, the frame includes a steering system. In yet further aspects, the frame can be configured to be partially submerged. In some aspects, the frame is partially submerged when the scoop is inserted into the substrate. In other aspects, the frame includes a flotation device. In further aspects, the frame includes an outboard propulsion device.

In some embodiments, the present disclosure is directed to a clam harvesting device for harvesting soft-shelled clams, having components including: a frame; a scoop pivotally mounted to a front of the frame, where the scoop is configured to move from a first position to a second position, where the scoop from the first position to the second position inserts the scoop into a substrate, and where the substrate contains one or more clams; a set of water jets on a surface of the scoop, where the set of water jets are configured to spay water into the substrate while the scoop is underneath the substrate, and where spraying the water loosens the substrate; a catchment area behind the scoop, where moving the scoop causes the loosened substrate and the one or more clams in the loosened substrate to enter the catchment area; a collection area; and a conveyer belt configured to transport the one or more clams form the catchment area to the collection area. In some implementations, the clam harvesting device further includes a pump configured to drive the set of water jets. In some aspects, the pump can be configured to recycle water. In other aspects, pressurized air can be used to drive the set of water jets. In some implementations, the clam harvesting device further is further configured such that the scoop includes a second set of water jets along a leading edge of the scoop, where the second of water jets assist the leading edge of the scoop in entering the sand when the scoop is inserted into the substrate. In some implementations, the clam harvesting device has a first pump configured to drive the first set of jets and a second pump configured to drive the second set of jets. In other implementations, the clam harvesting device has a pump configured to drive both the first set of jets and the second set of jets. In further aspects, the leading edge of the scoop includes teeth.

In some implementations, the clam harvesting device has the scoop is mounted to the frame using one or more hydraulic arms. In some aspects, when the scoop is in the first position, the scoop is out of the substrate, and when the scoop is in the second position, the scoop is underneath the substrate. In other aspects, a mount point of the scoop can be raised or lowered to raise or lower a height of the scoop. In some implementations, the clam harvesting device can further include a motor configured to drive the scoop from the first position to the second position. In some aspects, the scoop can be inserted up to three feet deep into the substrate. In other aspects, moving the scoop includes moving the frame and the scoop in a forward direction.

In some implementations, the clam harvesting device further includes a second set of water jets configured to separate the loosened substrate and the one or more clams in the catchment area. In some aspects, the catchment area further includes a grate through which the loosened substrate can flow. In other aspects, the collection area includes a clam sorted configure to sort clams by size. In further aspects, the clam harvesting device can further include a clam sorter configured to sort clams by size, where the clam sorter deposits clams less than or equal to a threshold size in a first container, and where the clam sorter deposits clams greater than the threshold size in a second container. In some aspects, the collection area includes a storage container for storing the one or more clams. In further aspects, the clam harvesting device further includes a chute mounted to the frame, where the chute is configured to return clams to the substrate. In other aspects, the frame includes vertical support members and a platform mounted on top of the vertical support members, where the collection area is on the platform.

In some implementations, the clam harvesting device further includes wheels mounted to the frame. In some aspects, a motor is configured to drive the wheels. In other aspects, one or more wheels include a motor. implementations, the clam harvesting device further includes treads mounted to the frame. In some aspects, the clam harvesting device further includes a steering system. In other aspects, the frame is configured to be partially submerged. In such aspects, the frame is partially submerged when the scoop is inserted into the substrate. In further aspects, a floatation tank is mounted to the frame. In other aspects, clam harvesting device also has an outboard propulsion device.

In some embodiments, the present disclosure is directed to a scoop for harvesting soft-shell clams, having: a leading edge configured to be inserted into a substrate; an upper surface located adjacent to the leading edge; a set of water jets mounted to the upper surface, where the set of water jets are configured to spray water into the substrate when the scoop is underneath the substrate; and a rear surface located adjacent to the upper surface, where the rear surface includes a mounting point for pivotally mounting the scoop to one or more arms. In some aspects, the scoop further includes a second set of water jets mounted to the leading edge, where the second set of jets assist the leading edge in entering the substrate when the scoop is inserted into the substrate. In some aspects, the leading edge includes teeth. In some implementations, the scoop further includes: a first side surface mounted between the upper surface and the rear surface; and a second side surface mounted between the upper surface and the rear surface opposite to the first side surface, where the first side surface and the second side surface each include an upper edge configured to assist the scoop in entering the substrate when the scoop is inserted into the substrate. In some aspects, the water jets are configured to liquefy the substrate. In further aspects, the scoop is connected to a pump configured to drive the set of water jets. In such aspects, the pump can be is mounted to the rear surface, and can be configured to recycle water. In other aspects, the scoop is configured to be inserted into sand up to three feet deep. In particular aspects, the scoop is configured for digging into wet sand.

### BRIEF DESCRIPTION OF THE DRAWINGS

Illustrative examples are described in detail below with reference to the following figures. It is intended that that embodiments and figures disclosed herein are to be considered illustrative rather than restrictive.

FIG. 1A illustrates an exemplary clam harvester in a perspective view, according to aspects of the disclosure.

FIG. 1B illustrates a side view of the exemplary clam harvester shown in FIG. 1A

FIG. 1C illustrates a front view of the exemplary clam harvester shown in FIG. 1A.

FIG. 1D illustrates a rear view of the exemplary clam harvester shown in FIG. 1A.

FIG. 1E illustrates a top view of the exemplary clam harvester shown in FIG. 1A.

FIG. 2 illustrates an alternative embodiment of an exemplary clam harvester in a side view, according to aspects of the disclosure.

FIG. 3 illustrates the exemplary clam harvester as shown in FIG. 1A, again in a perspective view, with some structures removed for clarity and understanding of portions of the clam harvester.

FIGS. 4A-4C illustrate a side view of a clam scoop moving from a first, non-harvesting position to a second, harvesting position.

FIG. 5A illustrates a perspective view of an exemplary clam scoop or harvesting tool, according to aspects of the disclosure.

FIG. 5B illustrates a front view of the exemplary harvesting tool shown in FIG. 5A.

FIG. 5C illustrates a side view of the exemplary harvesting tool shown in FIG. 5A.

FIG. 5D illustrates a top view of the exemplary harvesting tool shown in FIG. 5A.

FIG. 6 illustrates an cut-away schematic view of an exemplary clam scoop in the process of harvesting soft shell clams, according to aspects of the present disclosure.

### DETAILED DESCRIPTION

Various species of bivalve mollusks (or molluscs) can be found partially or fully buried in the sand of the ocean floor. Bivalve mollusks include clams, oysters, cockles, mussels, scallops, file shells, and the like, and can be saltwater or freshwater species. Some of these bivalve mollusks, in particular clams, are generally harvested out of the seabed for food. Clams can be harvested by manually digging the clams out of the sand. Mechanical devices, intended to more quickly harvest clams from the sand, can harvest clams in large quantities, including commercial quantities.

Prior approaches to harvesting clams in large quantities have traditionally been for the harvesting of hard shell clams. Hard shell clams tend to reside near the surface of sea floor at depths of 3 to 4 inches. Hard shell clams are generally able to sustain the standard impacts and jostling of harvesting methods without damage to the shells. Damaging the shell of a clam can not only prematurely kill the clam, but can also render the clam unsaleable.

One approach for a mechanical clam harvester for hard shell clams includes a sled with a containment basket or net. The containment basked is equipped with hydraulic water jets positioned to penetrate the surface of the sea bed. The water jets are located at an edge of the containment basket that is configured to penetrate the ground where clams are located and dislodge the clams. The dislodged clams can then be collected in the containment basket while the sled is being towed along the bottom of the sea floor by a surface vessel.

Another approach for a mechanical clam harvester for hard shell clams, used in shallow water locations, includes an inclined elevator attached to a surface vessel. The elevator can be a lifting device that mechanically lifts the clams scooped by the containment basket. The elevator is also equipped with hydraulic water jets positioned ahead of the end of the elevator. The starting point of the elevator is lowered into the water to penetrate the sea floor to dislodge the clams into the elevator. The elevator conveys the clams to the vessel as the vessel pushes the harvester forward along the sea floor.

Another approach for a mechanical clam harvester for hard shell clams includes a framework supported on a pair of runners. A set of jet nozzles is held below the runners, extending downwardly into the soil and below the surface of the sea floor. The set of jet nozzles inject pressurized fluid, away from the mechanical clam harvester, to dislodge the soil and clams. As the harvester is pulled long the seafloor, the dislodged soil and clams are suspended in a liquid suspension ahead of the nozzles. An enclosure net is mounted to the harvester behind the jet nozzles to sift through the liquid suspension and entrap the clams therein while allowing the suspended soil to settle back to its original location.

In contrast, soft shell clams, such as razor clams, reside much deeper in the sea floor with higher viscosity mud or sand, and have more delicate shells than hard-shelled varieties. Methods used by the mechanical harvesters for hard shell clams described above are generally prone to damage or break soft shell clams. Additionally, the methods and approaches discussed above as applied to soft shell clams can kill many of the immature clams that would otherwise be returned to the sea floor to mature.

Currently, soft shell clams can be harvested manually using hand tools such as rakes. However, while this traditional solution is effective, it is also very labor intensive and inefficient.

One attempted solution for harvesting soft shell clams has been without very intensive physical labor using surface vessels. However, examples surface vessels used for harvesting clams are generally prone to problems. In some cases, the vessel either surges forward or is not able to control its speed because of currents, winds, tides, and wave actions. Thus, inconsistent motion of the surface vessel can make the ability to maintain the harvesting vessel and components from functioning properly very difficult.

Another attempted solution for harvesting soft shell clams has been using a suction dredge for suction dredging on the sea floor to remove soft shell clams. This solution however, is also problematic because of the suction dredging's environmental impact. In sandy substrates or where high volumes of sand must be excavated to capture the clams, the extensive amount of sediment that is discharged back in the water can pose an ecological threat to the environment.

Another attempted solution for harvesting soft shell clams has been using a mechanical clam harvester. The solution, for the soft shell clams, attempts to dislodge the clams with water jets positioned beneath the surface of the sea floor that shoots water directly forward from the containment net. However, this solution is generally prone to damaging the soft shell clams either by the pressure of the water jets directly hitting the soft shell clams or by pressures exerted on the clams when the clams are forced against each other as they accumulate in the containment net and are hauled to surface.

Another attempted solution for harvesting soft shell clams has been to first soften the mud of the seafloor and creating a slurry. Many soft shell clams can be located inside mud or sand in the sea floor. However, solutions to retrieve the soft shell clams from the slurry mechanically by a harvester have not been established.

Accordingly, a solution for mechanically harvesting soft shell clams that is not labor intensive, mechanically practical, and does not damage soft shell clams' ecosystem is needed.

In various implementations, a mechanical clam harvester is provided for harvesting soft shell clams. The clam harvester is capable of traversing the sea floor in sub-tidal areas, where soft shell clams, such as razor clams, can be located. Because the harvester is able to traverse over the surface of the sea floor, the harvester provides a solid platform, and is configured to withstand and not be affected by currents, winds, tides, or wave actions, such as the case with surface vessels. Having a solid platform enables precise control of the speed, water volumes, pressures, and substrate penetration to harvest clams in a manner is less likely to harm the clams or create an ecological threat to the environment. In addition, undersized and immature clams that are collected can be immediately returned to the soft sand to grow and further develop. Because the harvester operates in sub-tidal zones, those clams that are retained can be immediately packed into meshed bags or other types of containers. The containers with the clams can be returned to the water, where the clams can be held live. The containers can later retrieved and transported to either a processing facility or used to reseed other locations.

While the exemplary applications considered herein discuss the harvesting of claims, and in particular soft-shell clams, the present innovative system, platforms, and methods are also applicable toward the harvesting of other bivalve mollusks from riverbeds or seabeds.

In one example, a clam harvester is provided that includes a frame that can be at least partially submerged under water. The frame supports a “clam scoop,” which, as described herein, includes a shovel or a bucket that maybe similar to a backhoe bucket. The clam scoop is configured to support a set of water jets that inject water into a substrate containing sand, mud, and soft shell clams as the scoop penetrates the substrate. The water mixes with the substrate to turn the substrate into a fluidized slurry. The clam scoop can collect the slurry and move the slurry to a collection area of the harvester. In one example, the collection area can include a grate, where the clams can be separated from the sand. The clams can then be moved, using a lifting device to a platform of the clam harvester. The platform can supports a sorting area where the clams can be sorted and either packaged into containers for or returned to the sea floor.

The exemplary clam scoop is particularly configured to dig sufficiently deep into the substrate, and also to penetrate and loosen the substrate. The target clams form silos in the substrate, where the sand surrounding and forming the silo is relatively harder (more compacted, having additional characters in its mixture increasing viscosity, etc.) than the remainder of the substrate. Further, the silo formed by a clam can have an extended depth used as an escape tunnel, such that the clam can drop deeper into the silo and out of the range of predators. Accordingly, the exemplary clam scoop can be driven under and through the substrate to (i) cut underneath the silo or through the silo at a sufficient depth, and (ii) to disrupt, loosen, fluidize, and/or liquefy the sand substrate forming the silo. In some aspects, water injected at a high pressure along the leading edge of the scoop can disrupt the sand forming the bottom portion of a silo, thereby cutting off the escape tunnel of a target clam. In other aspects, the water jets on the primary surface of the clam scoop can also aid in floating up the clams swept up by the scoop as they are collected and moved to a storage container on the device.

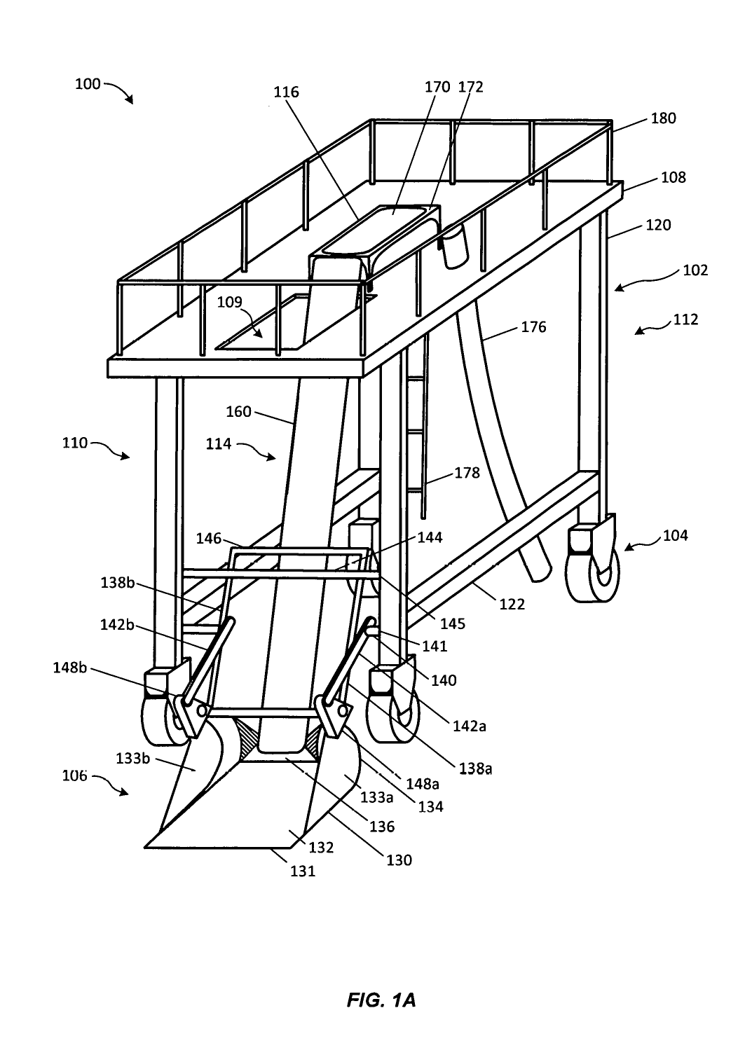

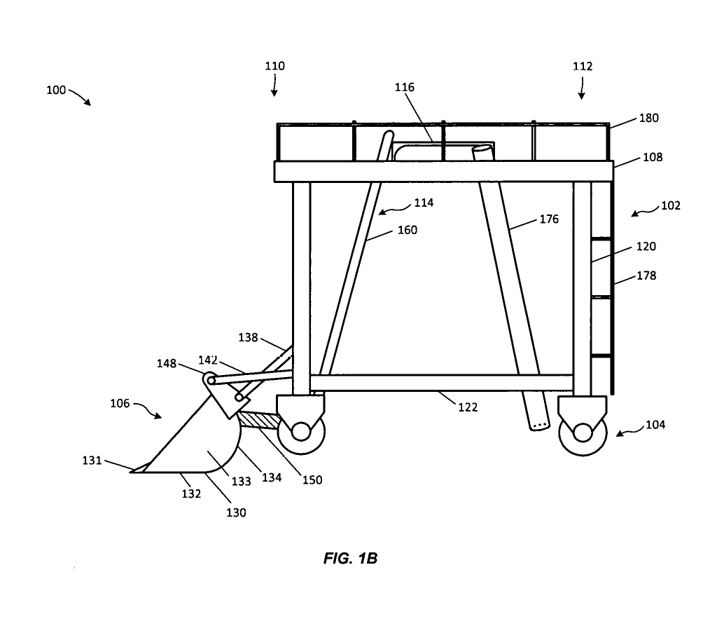

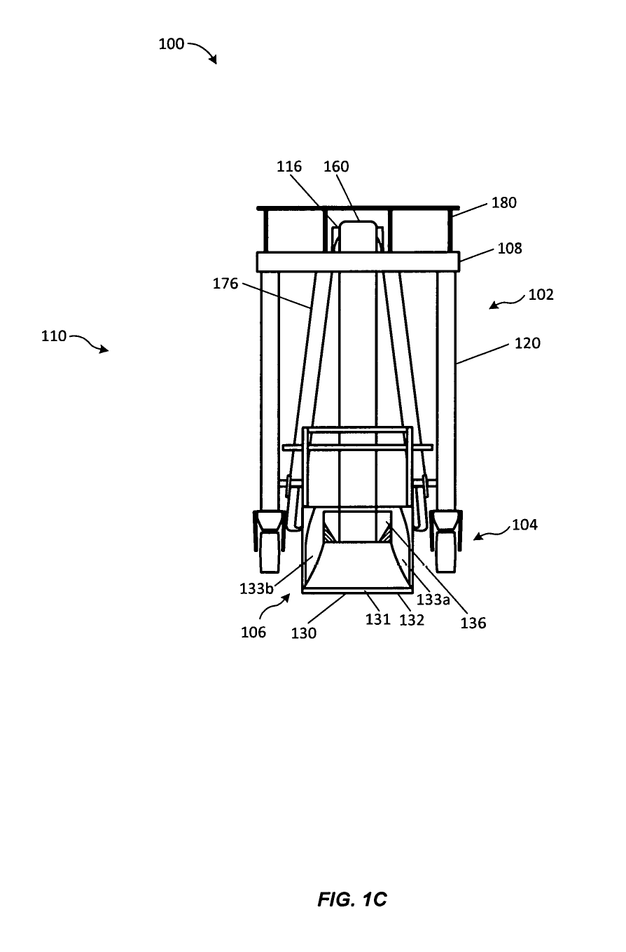

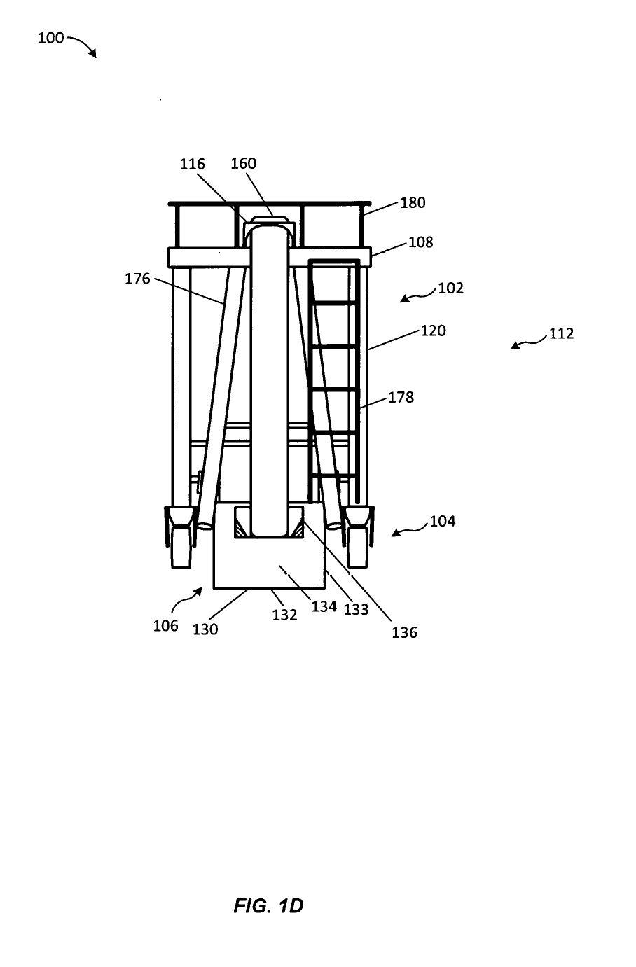

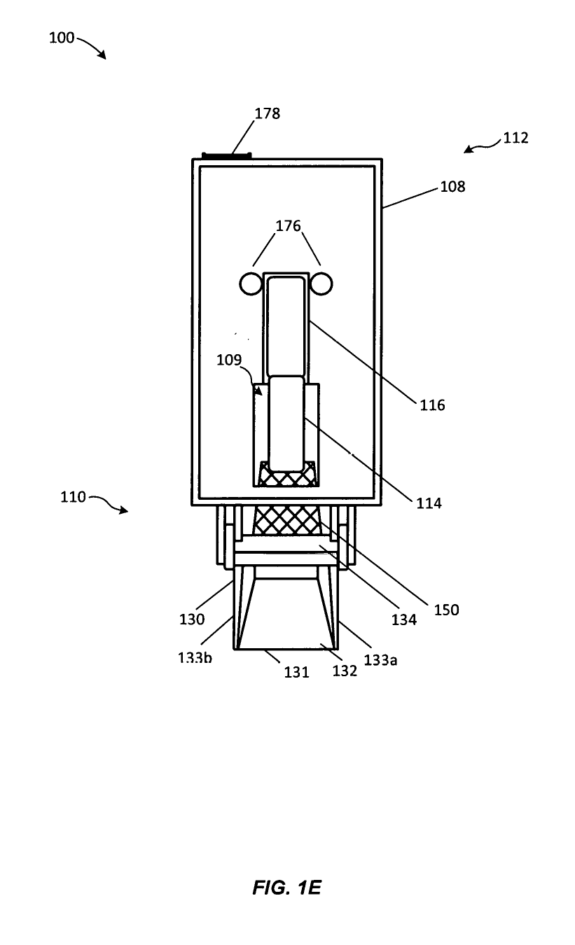

FIGS. 1A-1E illustrate different views of an example of a mechanical clam harvester for harvesting soft shell clams. In some of the figures, some components have been removed to simplify the drawing so that the drawing can focus on the key aspects of the example clam harvester. Other drawings below illustrate the components that have been removed.

FIG. 1A illustrates an example of a clam harvester 100 (alternatively referred to as a mechanical clam harvester, a clam harvesting device, or a clam harvesting assembly) in a perspective view. The clam harvester 100 includes a frame 102 and a moving mechanism 104 attached to the frame. The frame also includes a front portion 110 and a rear portion 112 such that the front portion 110 supports a clam scoop 106 (alternatively referred to as a clam scoop assembly) located at the front portion of the frame. A platform 108 can be mounted above the frame and includes a sorting area 116. A lifting device 114 couples the clam scoop 106 with the sorting area 116 on the platform 108. The lifting device 114 moves clams collected by the clam scoop 106 vertically to the sorting area 116.

In one example, the frame 102 includes a plurality of legs 120 (alternatively referred to as vertical support members) proximate to each of the front portion 110 and rear portion 112 of the frame 102, connected by at least one support beam 122. The legs 120 and at least one support beam 122 form a rectangular shape that supports the platform 108 and clam scoop 106. In another example, the frame includes four legs 120 connected by two support beams 122, where the platform 108 can be mounted on top of the four legs 120.

In one example, the moving mechanism 104 can be a set of wheels that can be attached to each leg 120 of the frame 102. In one example, the wheels can be casters. The wheels can be mechanically connected to each other by an axle or axles or individually mounted independent of each other. In another example, the wheels can swivel casters wherein each caster can move on a surface in any direction independent of any of the other casters. In another example, the moving mechanism 104 can be hydraulically actuated with at least one piston to the frame 102. In another example, the wheels can be rotated by a motor (or motors) configured to drive the wheels. In another example, the wheels can be driven by motors inside of each wheel. In another example, the wheels turn by a hydraulic turning system and move by a hydraulic driveshaft. In another example, the moving mechanism 104 includes wheels that have 4-wheel electric drive. In another example, the moving mechanism 104 includes wheels that can be driven by electric motors, independently of each other. In another example, a steering system drives and steers the clam harvester 100. In another example, the wheels include mud or sand tires or any tires with treads.

In one example, the clam scoop 106 can be pivotally mounted to the front portion of the frame 102. In one example, the clam scoop 106 includes a bucket 130 and a connecting assembly that connects the bucket to the frame. The bucket 130 includes a leading edge 131, a base portion 132, a raised portion 134 (alternatively referred to as a rear portion or an inclined portion), and two side surfaces 133a and 133b mounted between the base portion 132 and raised portion 134. In one example, the base portion 132 can be a planar surface that is generally flat and can be inclined relative to the seafloor. In one example, the raised portion 134 of the bucket has an opening 136. In another example, the leading edge 131 of the bucket includes teeth or tines. In another example, the leading edge 131 can be a blade. In one example, the base portion 132 supports a set of water ports and water jets (shown in later figures). The water jets are configured to fluidize a substrate on the ground to create a slurry where clams can float to the surface while at least the base portion 132 of the bucket 130 is configured to be underneath the habitat depth of the soft shell clams.

In another example, the connecting assembly includes a first support axle 140 connected to the legs 120 at the front portion of the frame 102 at a first pivot axis 141. The first support axle 140 can be coupled to one end of a link arm 138a and one end of a link arm 138b. The bucket 130 can be coupled to another end of the link arm 138a and another end of link arm 138b. In another example, the link arms 138a and 138b are pivotally connected to flat plates 148a and 148b, respectively, that protrude from the sides 133a and 133b of the bucket 130, respectively. In one configuration, the first support axle 140 and link arms 138a and 138b are locked and do not pivot about the first pivot axis 141. In another configuration, the first support axle 140 and link arms 138a and 138b can rotate about the first pivot axis 141 to allow the bucket to move to various positions. In another configuration, the first support axle 140 and link arms 138a and 138b can pivot to allow height adjustment of the bucket 130. The connecting assembly can include a second support axle 144 at a second pivot axis 145. The second support axle 144 can be pivotally coupled to one end of a second link arm or rocker arm 142a and one end of a rocker arm 142b. The rocker arms 142a and 142b are pivotally connected to flat plates 148a and 148b, respectively. The second support axle 144 and rocker arms 142a and 142b can rotate about the second pivot axis 145 to allow the bucket to move to various positions. In another example, the rocker arms 142a and 142b extend beyond the pivot axle 144 and are connected by a crossbar 146. The crossbar 146 can be configured as a handlebar for a user to manually move the bucket 130 from one position to another position. In another example, the connecting assembly of the clam scoop 106 can be mounted to the frame 102 with one or more hydraulic arms. In another example, at least one of pivot axle 140 and 144 are coupled to at least one motor that turn the pivot axle or axles and move the bucket 130 from one position to another position. In one example, the clam scoop 106 can be mounted to the front portion of the frame 102 with a pair of fixed arms and a pair and hydraulic rotators pivotally connecting the pair of fixed arms and the clam scoop 106.

In one example, the clam scoop 106 can be configured to move from a non-harvesting position to a harvesting position. In the harvesting position, the leading edge 131 of the bucket 130 can engage a substrate of sand or mud in a sand bed or mud bed by submerging underneath the sand bed or mud bed. When engaged, the leading edge 131 and at least a portion of the base portion 132 of the bucket 130 is configured to be underneath the substrate surface and the soft shell clam depth habitat. The bucket 130 can be partially submerged into water or fully submerged into water. The frame 102 can also be partially submerged into water to allow the clam scoop 130 to engage a deeper sand bed. In another example, the bucket 130 can be inserted up to three feet (3′) deep into the sand bed. In one example, the clam scoop 106 can move continuously through a sand bed in the harvesting position while the frame 102 can be moving continuously with the clam scoop 106. In other words, the clam scoop 106 can be driven through a substrate by the motorized clam harvesting vehicle.

In one example, the bucket 130 of the clam scoop 106 includes an opening 136 that serves as a gate to a catchment area for any substrate captured. The fluidized slurry can flow from the leading edge 131 of the bucket 130, through the base portion 132, and out of the bucket 130 to the catchment area behind the raised portion 134 of the bucket 130. In another example, the substrate proceeds through a filtration system and clams can be moved from the bucket 130 through an opening 136 to the filtration system, and then to the lifting device 114 that lifts any clams captured by the bucket 130 to the sorting area 116 of the clam harvester 100.

In one example, the lifting device 114 can be a mechanically driven conveyor belt 160 with a plurality of buckets or cleats that catch the clams from the bucket 130 and lifted by the conveyor belt 160 to the platform 108. In another example, the lifting device 114 can be a lifting chute, a hopper belt or any other lifting device or motorized lifting device known in the art for loading and unloading products. In a further example, the lifting device 114 can be a clam transfer tube. The transfer tube carries the clams collected by the clam scoop 106 vertically or substantially vertically towards the platform 108 using an impeller-less pump. A dewatering pump can be configured at the top of the clam transfer tube to remove water from the clams as the clams move from the transfer tube or impeller-less pump to the sorting area 116.

In one example, the platform 108 spans over the legs 120 of the frame 102. In another example, the platform has a rail 180 surrounding the platform for safety when work is performed on the platform. A ladder 178 can be coupled to the rear portion of the frame 102 and platform 108 to allow access to the platform. The sorting area 116 can be mounted on the platform 108 towards the center of the platform. The sorting area 116 can include a sorting belt 170 that is configured to carry clams provided by the lifting device 114. In another example, a hole or cutout 109 can be formed in the platform 108 where the lifting device 114 can extend from underneath the platform through the hole and ends at the sorting area 116. Underneath the sorting belt 170 can be a plate that can catch any unsorted clams that move along the sorting belt. The sorting belt 170 can be configured to sort clams by size and discard any unwanted materials or clams. The sorting belt 170 can also filter clams of a certain size that the clams can be equal to or less than a threshold size and discharge the clams that are too small through a return chute 176 (alternatively referred to as a discharge chute). A clam chute (not shown) can be used to move the desired clams to a location away from the clam harvester 100. In one example, the sorting belt 170, plate, and return chute 176 are part of a sorting trough 172. The return chute 176 can return the unwanted clams back to the loosened substrate area previously picked up by the clam harvester 100 so the clams can easily re-burrow and grow to harvestable maturity or such that the clams can be greater than the threshold size and packed in mesh bags or other suitable containment devices.

FIG. 1B illustrates a side view of the example clam harvester 100 provided in FIG. 1A. As illustrated in FIG. 1B, the clam harvester 100 includes a frame 102 and a moving mechanism 104 attached to the frame. The frame also includes a front portion 110 and a rear portion 112 such that the front portion 110 supports a clam scoop 106 located at the front portion of the frame. A platform 108 is mounted above the frame and includes a sorting area 116. A lifting device 114 couples the clam scoop 106 with the sorting area 116 on the platform 108. The lifting device 114 moves clams collected by the clam scoop 106 vertically or substantially vertically to the sorting arca 116.

In one example, the frame 102 includes a plurality of legs 120 proximate to each of the front portion 110 and rear portion 112 of the frame 102, connected by at least one support beam 122. The legs 120 and at least one support beam 122 form a rectangular shape that supports the platform 108 and clam scoop 106. In another example, the frame includes four legs 120 connected by two support beams 122 and the platform 108 is mounted on top of the four legs.

In one example, the moving mechanism 104 can be a set of wheels that can be attached to each leg 120 of the frame 102. In one example, the moving mechanism 104 is hydraulically actuated with at least one piston to the frame 102. In another example, the wheels can be rotated by a motor or motors configured to drive the wheels. In another example, the wheels can be driven by motors inside of each wheel. In another example, the wheels turn by a hydraulic turning system and move by a hydraulic driveshaft. In another example, the moving mechanism 104 includes wheels that have 4-wheel electric drive. In another example, the moving mechanism 104 includes wheels that can be driven by electric motors, independently of each other. In another example, a steering system drives and steers the clam harvester 100. In another example, the wheels include mud or sand tires or any tires with treads.

In one example, the clam scoop 106 is pivotally mounted to the front portion of the frame 102. In one example, the clam scoop 106 includes a bucket 130 and a connecting assembly that connects the bucket to the frame. The bucket 130 includes a leading edge 131, a base portion 132, a raised portion 134, and two side surfaces 133 mounted between the base portion 132 and raised portion 134. In one example, the base portion 132 can be a planar surface that is generally flat and can be inclined relative to the seafloor. In one example, the raised portion 134 of the bucket has an opening 136 (not shown). In another example, the leading edge 131 of the bucket includes teeth or tines. In another example, the leading edge 131 is a blade. In one example, the base portion also supports a set of water ports and water jets (shown in later figures). The water jets fluidize a substrate on the ground to create a slurry where clams can float to the surface while at least the base portion 132 of the bucket 130 is configured to be underneath the habitat depth of the clams.

In another example, the connecting assembly includes a support axle connected to the front portion 110 of the frame 102 at a pivot axis. The support axle can be coupled to a first end of link arm 138. The bucket 130 is coupled to another end of the link arm 138. In another example, the link arm 138 is pivotally connected to a flat plate 148 that protrude from the side 133 of the bucket 130. In one example, the support axle and link arm 138 can be locked and is configured to not pivot about an axis. In another example, the support axle and link arm 138 can rotate about the pivot axis to allow the bucket to move to various positions. In another example, the support axle and link arm 138 can pivot to allow height adjustment of the bucket 130. The connecting assembly can include a second support axle at a second pivot axis. The second support axle is pivotally coupled to one end of a second link arm or rocker arm 142. The rocker arm 142 can be pivotally connected to flat plate 148. The second support axle and rocker arm 142 can rotate about the second pivot axis to allow the bucket to move to various positions. In another example, the rocker arm 142 can extend beyond the pivot axle. In another example, the connecting assembly of the clam scoop 106 is mounted to the frame 102 with one or more hydraulic arms. In another example, at least one of pivot axle 140 and 144 are coupled to at least one motor that turn the pivot axle or axles and move the bucket 130 from one position to another position. In one example, the clam scoop 106 is mounted to the front portion of the frame 102 with a pair of fixed arms and a pair and hydraulic rotators pivotally connecting the pair of fixed arms and the clam scoop 106.

In one example, the clam scoop is configured to move from a non-harvesting position to a harvesting position. In the harvesting position, the leading edge 131 of the bucket 130 is submerged underneath a sand bed or mud bed to engage a substrate. When engaged, the leading edge 131 and at least a portion of the base portion 132 of the bucket 130 is configured to be underneath the substrate surface and the clam depth habitat. The clam scoop 130 can be partially submerged into water or fully submerged into water. The frame 102 can also be partially submerged into water to allow the clam scoop 130 to engage a deeper sand bed. In another example, the bucket 130 can be inserted up to three feet (3′) deep into the sand bed. In one example, the clam scoop 106 can move continuously through a sand bed in the harvesting position while the frame 102 is moving continuously with the clam scoop. In other words, the clam scoop 106 can be driven through a substrate by the motorized clam harvesting vehicle.

In one example, the bucket 130 of the clam scoop 106 includes an opening 136 that serves as a gate to a catchment area for any substrate captured. The connection of the clam scoop 106 and frame is configured such that the fluidized slurry can flow from the leading edge 131 of the bucket 130, through the base portion 132, and out of the bucket to the catchment area behind the raised portion 134 of the bucket. In another example, the substrate proceeds through a filtration system and clams can be moved from the bucket through an opening 136 to the filtration system, and then to the lifting device 114 that lifts any clams captured by the bucket to the sorting area 116 of the clam harvester 100.

In another example, the catchment area can also be a filtration system for any substance, clams, or fluidized substrate or slurry. The filtration system includes at least a grate 150 which links the raised portion 134 of the bucket 130 at an opening 136 (not shown) to the lifting device 114. The grate 150 is configured to further allow the catchment area to filter unwanted substance such as sand or mud so that only a substrate with a substantial amount of clams or only clams can move passed the grate to the lifting device 114. In another example, the clam scoop 106 also includes at least one water pump (shown in later figures) that is configured to wash the substrate as it moves along the grate 150 to separate the unwanted substance and the clams more easily. Other examples of the filtration system, including using water jets, are described in detail in other figures.

In one example, the lifting device 114 is a mechanically driven conveyor belt 160 with a plurality of buckets or cleats that catch the clams from the bucket 130 and lifted by the conveyor belt 160 to the platform 108. In one example, the lifting device 114 is a lifting chute, a hopper belt or any other lifting device or motorized lifting device known in the art for loading and unloading products. In another example, the lifting device 114 can be a clam transfer tube. The transfer tube carries the clams collected by the clam scoop 106 vertically or substantially vertically towards the platform 108 using an impeller-less pump. A dewatering pump can be configured at the top of the clam transfer tube to remove water from the clams as the clams move from the transfer tube or impeller-less pump to the sorting area 116.

In one example, the platform 108 spans over the legs 120 of the frame 102. In another example, the platform has a rail 180 surrounding the platform for safety when work is performed on the platform. A ladder 178 is coupled to a rear portion of the frame 102 and platform 108 to allow access to the platform. The sorting area 116 is mounted on the platform 108 towards the center of the platform. The sorting area 116 can include a sorting belt 170 that is configured to carry clams provided by the lifting device 114. Underneath the sorting belt 170 is a plate that can catch any unsorted clams that moves along the sorting belt. The sorting belt 170 is configured to sort clams by size and discard any unwanted materials or clams. The sorting belt 170 can also filter clams of a certain size that is equal to or less than a threshold size and discharge the clams that are too small through a return chute 176. A clam chute (not shown) can be used to move the desired clams to a location away from the clam harvester 100. The return chute 176 is configured to return the unwanted clams back to the loosened substrate area previously picked up by the clam harvester 100 so the clams can easily re-burrow and grow to harvestable maturity or such that the clams can be greater than the threshold size and packed in mesh bags or other suitable containment devices.

FIG. 1C illustrates a front view of the example provided in FIG. 1A. In one example, as illustrated in FIG. 1C, the clam harvester 100 includes a frame 102 and a moving mechanism 104 attached to the frame. The frame also includes a front portion 110 and a rear portion 112 such that the front portion 110 supports a clam scoop 106 located at the front portion of the frame. A platform 108 is mounted above the frame and includes a sorting area 116. A lifting device 114 couples the clam scoop 106 with the sorting area 116 on the platform 108. The lifting device 114 moves clams collected by the clam scoop 106 vertically or substantially vertically to the sorting area 116.

In one example, the frame 102 includes a plurality of legs 120 proximate to each of the front portion 110 and rear portion 112 of the frame 102, connected by at least one support beam 122. The legs 120 and at least one support beam 122 form a rectangular shape that supports the platform 108 and clam scoop 106. In another example, the frame includes four legs 120 connected by two support beams 122 and the platform 108 is mounted on top of the four legs.

In one example, the moving mechanism 104 can be a set of wheels that can be attached to each leg 120 of the frame 102. In one example, the moving mechanism 104 is hydraulically actuated with at least one piston to the frame 102. In another example, the wheels can be rotated by a motor or motors configured to drive the wheels. In another example, the wheels can be driven by motors inside of each wheel. In another example, the wheels turn by a hydraulic turning system and move by a hydraulic driveshaft. In another example, the moving mechanism 104 includes wheels that have 4-wheel electric drive. In another example, the moving mechanism 104 includes wheels that can be driven by electric motors, independently of each other. In another example, a steering system drives and steers the clam harvester 100. In another example, the wheels include mud or sand tires or any tires with treads.

In one example, the clam scoop 106 is pivotally mounted to the front portion of the frame 102. In one example, the clam scoop 106 includes a bucket 130 and a connecting assembly that connects the bucket to the frame. The bucket 130 includes a leading edge 131, a base portion 132, a raised portion 134, and two side surfaces 133 mounted between the base portion 132 and raised portion 134. In one example, the base portion 132 can be a planar surface that is generally flat and can be inclined relative to the seafloor. In one example, the raised portion 134 of the bucket has an opening 136. In another example, the leading edge 131 of the bucket includes teeth or tines. In another example, the leading edge 131 is a blade. In one example, the base portion also supports a set of water ports and water jets (shown in later figures). The water jets fluidize a substrate on the ground to create a slurry where clams can float to the surface while at least the base portion 132 of the bucket 130 is con figured to be underneath the habitat depth of the clams.

In another example, the connecting assembly includes a support axle connected to the front portion 110 of the frame 102 at a pivot axis. The support axle can be coupled to a first end of link arm 138. The bucket 130 is coupled to another end of the link arm 138. In another example, the link arm 138 is pivotally connected to a flat plate 148 that protrude from the side 133 of the bucket 130. In one example, the support axle and link arm 138 can be locked and is configured to not pivot about an axis. In another example, the support axle and link arm 138 can rotate about the pivot axis to allow the bucket to move to various positions. In another example, the support axle and link arm 138 can pivot to allow height adjustment of the bucket 130. The connecting assembly can include a second support axle at a second pivot axis. The second support axle is pivotally coupled to one end of a second link arm or rocker arm 142. The rocker arm 142 can be pivotally connected to flat plate 148. The second support axle and rocker arm 142 can rotate about the second pivot axis to allow the bucket to move to various positions. In another example, the rocker arm 142 can extend beyond the pivot axle. In another example, the connecting assembly of the clam scoop 106 is mounted to the frame 102 with one or more hydraulic arms. In another example, at least one of pivot axle 140 and 144 are coupled to at least one motor that turn the pivot axle or axles and move the bucket 130 from one position to another position. In one example, the clam scoop 106 is mounted to the front portion of the frame 102 with a pair of fixed arms and a pair and hydraulic rotators pivotally connecting the pair of fixed arms and the clam scoop 106.

In one example, the clam scoop is configured to move from a non-harvesting position to a harvesting position. In the harvesting position, the leading edge 131 of the bucket 130 is submerged underneath a sand bed or mud bed to engage a substrate. When engaged, the leading edge 131 and at least a portion of the base portion 132 of the bucket 130 is configured to be underneath the substrate surface and the clam depth habitat. The clam scoop 130 can be partially submerged into water or fully submerged into water. The frame 102 can also be partially submerged into water to allow the clam scoop 130 to engage a deeper sand bed. In another example, the bucket 130 can be inserted up to three feet (3′) deep into the sand bed. In one example, the clam scoop 106 can move continuously through a sand bed in the harvesting position while the frame 102 is moving continuously with the clam scoop. In other words, the clam scoop 106 can be driven through a substrate by the motorized clam harvesting vehicle.

In one example, the bucket 130 of the clam scoop 106 includes an opening 136 that serves as a gate to a catchment area for any substrate captured. The connection of the clam scoop 106 and frame is configured such that the fluidized slurry can flow from the leading edge 131 of the bucket 130, through the base portion 132, and out of the bucket to the catchment area behind the raised portion 134 of the bucket. In another example, the substrate proceeds through a filtration system and clams can be moved from the bucket through an opening 136 to the filtration system, and then to the lifting device 114 that lifts any clams captured by the bucket to the sorting area 116 of the clam harvester 100.

In another example, the catchment area can also be a filtration system for any substance, clams, or fluidized substrate or slurry. The filtration system includes at least a grate 150 which links the raised portion 134 of the bucket 130 at an opening 136 to the lifting device 114. The grate 150 is configured to further allow the catchment area to filter unwanted substance such as sand or mud so that only a substrate with a substantial amount of clams or only clams can move passed the grate to the lifting device 114. In another example, the clam scoop 106 also includes at least one water pump (shown in later figures) that is configured to wash the substrate as it moves along the grate 150 to separate the unwanted substance and the clams more easily. In another example, the opening 136 can receive a continuous amount of substrate when the clam harvester 100 moves along a sand bed. In another example, the base portion 132 of the bucket 130 can be wider than that of the raised portion 134 to allow for a better continuous flow of the slurry passing through the bucket and to the grate 150. Other examples of the filtration system, including using water jets, are described in detail in other figures.

In one example, the lifting device 114 is a mechanically driven conveyor belt 160 with a plurality of buckets or cleats that catch the clams from the bucket 130 and lifted by the conveyor belt 160 to the platform 108. In one example, the lifting device 114 is a lifting chute, a hopper belt or any other lifting device or motorized lifting device known in the art for loading and unloading products. In another example, the lifting device 114 can be a clam transfer tube. The transfer tube carries the clams collected by the clam scoop 106 vertically or substantially vertically towards the platform 108 using an impeller-less pump. A dewatering pump can be configured at the top of the clam transfer tube to remove water from the clams as the clams move from the transfer tube or impeller-less pump to the sorting area 116.

In one example, the platform 108 spans over the legs 120 of the frame 102. In another example, the platform has a rail 180 surrounding the platform for safety when work is performed on the platform. A ladder 178 is coupled to a rear portion of the frame 102 and platform 108 to allow access to the platform. The sorting area 116 is mounted on the platform 108 towards the center of the platform. The sorting area 116 can include a sorting belt 170 that is configured to carry clams provided by the lifting device 114. Underneath the sorting belt 170 is a plate that can catch any unsorted clams that moves along the sorting belt. The sorting belt 170 is configured to sort clams by size and discard any unwanted materials or clams. The sorting belt 170 can also filter clams of a certain size that is equal to or less than a threshold size and discharge the clams that are too small through a return chute 176. A clam chute (not shown) can be used to move the desired clams to a location away from the clam harvester 100. In one example, the sorting belt 170, plate, and return chute 176 are part of a sorting trough 172. The return chute 176 is configured to return the unwanted clams back to the loosened substrate area previously picked up by the clam harvester 100 so the clams can easily re-burrow and grow to harvestable maturity or such that the clams can be greater than the threshold size and packed in mesh bags or other suitable containment devices.

FIG. 1D illustrates a rear view of the example provided in FIG. 1A. As illustrated in FIG. 1D, the clam harvester 100 includes a frame 102 and a moving mechanism 104 attached to the frame. The frame also includes a front portion 110 and a rear portion 112 such that the front portion 110 supports a clam scoop 106 located at the front portion of the frame. A platform 108 is mounted above the frame and includes a sorting area 116. A lifting device 114 couples the clam scoop 106 with the sorting area 116 on the platform 108. The lifting device 114 moves clams collected by the clam scoop 106 vertically or substantially vertically to the sorting area 116.

In one example, the frame 102 includes a plurality of legs 120 proximate to each of the front portion 110 and rear portion 112 of the frame 102, connected by at least one support beam 122. The legs 120 and at least one support beam 122 form a rectangular shape that supports the platform 108 and clam scoop 106. In another example, the frame includes four legs 120 connected by two support beams 122 and the platform 108 is mounted on top of the four legs.

In one example, the moving mechanism 104 can be a set of wheels that can be attached to each leg 120 of the frame 102. In one example, the moving mechanism 104 is hydraulically actuated with at least one piston to the frame 102. In another example, the wheels can be rotated by a motor or motors configured to drive the wheels. In another example, the wheels can be driven by motors inside of each wheel. In another example, the wheels turn by a hydraulic turning system and move by a hydraulic driveshaft. In another example, the moving mechanism 104 includes wheels that have 4-wheel electric drive. In another example, the moving mechanism 104 includes wheels that can be driven by electric motors, independently of each other. In another example, a steering system drives and steers the clam harvester 100. In another example, the wheels include mud or sand tires or any tires with treads.

In one example, the clam scoop 106 is pivotally mounted to the front portion of the frame 102. In one example, the clam scoop 106 includes a bucket 130 and a connecting assembly that connects the bucket to the frame. The bucket 130 includes a leading edge 131, a base portion 132, a raised portion 134, and two side surfaces 133 mounted between the base portion 132 and raised portion 134. In one example, the base portion 132 can be a planar surface that is generally flat and can be inclined relative to the seafloor. In one example, the raised portion 134 of the bucket has an opening 136. In another example, the leading edge 131 of the bucket includes teeth or tines. In another example, the leading edge 131 is a blade. In one example, the base portion also supports a set of water ports and water jets (shown in later figures). The water jets fluidize a substrate on the ground to create a slurry where clams can float to the surface while at least the base portion 132 of the bucket 130 is configured to be underneath the habitat depth of the clams.

In another example, the connecting assembly includes a support axle connected to the front portion 110 of the frame 102 at a pivot axis. The support axle can be coupled to a first end of link arm 138. The bucket 130 is coupled to another end of the link arm 138. In another example, the link arm 138 is pivotally connected to a flat plate 148 that protrude from the side 133 of the bucket 130. In one example, the support axle and link arm 138 can be locked and is configured to not pivot about an axis. In another example, the support axle and link arm 138 can rotate about the pivot axis to allow the bucket to move to various positions. In another example, the support axle and link arm 138 can pivot to allow height adjustment of the bucket 130. The connecting assembly can include a second support axle at a second pivot axis. The second support axle is pivotally coupled to one end of a second link arm or rocker arm 142. The rocker arm 142 can be pivotally connected to flat plate 148. The second support axle and rocker arm 142 can rotate about the second pivot axis to allow the bucket to move to various positions. In another example, the rocker arm 142 can extend beyond the pivot axle. In another example, the connecting assembly of the clam scoop 106 is mounted to the frame 102 with one or more hydraulic arms. In another example, at least one of pivot axle 140 and 144 are coupled to at least one motor that turn the pivot axle or axles and move the bucket 130 from one position to another position. In one example, the clam scoop 106 is mounted to the front portion of the frame 102 with a pair of fixed arms and a pair and hydraulic rotators pivotally connecting the pair of fixed arms and the clam scoop 106.

In one example, the clam scoop is configured to move from a non-harvesting position to a harvesting position. In the harvesting position, the leading edge 131 of the bucket 130 is submerged underneath a sand bed or mud bed to engage a substrate. When engaged, the leading edge 131 and at least a portion of the base portion 132 of the bucket 130 is configured to be underneath the substrate surface and the clam depth habitat. The clam scoop 130 can be partially submerged into water or fully submerged into water. The frame 102 can also be partially submerged into water to allow the clam scoop 130 to engage a deeper sand bed. In another example, the bucket 130 can be inserted up to three feet (3′) deep into the sand bed. In one example, the clam scoop 106 can move continuously through a sand bed in the harvesting position while the frame 102 is moving continuously with the clam scoop. In other words, the clam scoop 106 can be driven through a substrate by the motorized clam harvesting vehicle.

In one example, the bucket 130 of the clam scoop 106 includes an opening 136 that serves as a gate to a catchment area for any substrate captured. The connection of the clam scoop 106 and frame is configured such that the fluidized slurry can flow from the leading edge 131 of the bucket 130, through the base portion 132, and out of the bucket to the catchment area behind the raised portion 134 of the bucket. In another example, the substrate proceeds through a filtration system and clams can be moved from the bucket through an opening 136 to the filtration system, and then to the lifting device 114 that lifts any clams captured by the bucket to the sorting area 116 of the clam harvester 100.

In another example, the catchment area can also be a filtration system for any substance, clams, or fluidized substrate or slurry. The filtration system includes at least a grate 150 which links the raised portion 134 of the bucket 130 at an opening 136 to the lifting device 114. The grate 150 is configured to further allow the catchment area to filter unwanted substance such as sand or mud so that only a substrate with a substantial amount of clams or only clams can move passed the grate to the lifting device 114. In another example, the clam scoop 106 also includes at least one water pump (shown in later figures) that is configured to wash the substrate as it moves along the grate 150 to separate the unwanted substance and the clams more easily. In another example, the opening 136 can receive a continuous amount of substrate when the clam harvester 100 moves along a sand bed. In another example, the base portion 132 of the bucket 130 can be wider than that of the raised portion 134 to allow for a better continuous flow of the slurry passing through the bucket and to the grate 150. Other examples of the filtration system, including using water jets, are described in detail in other figures.

In one example, the lifting device 114 is a mechanically driven conveyor belt 160 with a plurality of buckets or cleats that catch the clams from the bucket 130 and lifted by the conveyor belt 160 to the platform 108. In one example, the lifting device 114 is a lifting chute, a hopper belt or any other lifting device or motorized lifting device known in the art for loading and unloading products. In another example, the lifting device 114 can be a clam transfer tube. The transfer tube carries the clams collected by the clam scoop 106 vertically or substantially vertically towards the platform 108 using an impeller-less pump. A dewatering pump can be configured at the top of the clam transfer tube to remove water from the clams as the clams move from the transfer tube or impeller-less pump to the sorting area 116.

In one example, the platform 108 spans over the legs 120 of the frame 102. In another example, the platform has a rail 180 surrounding the platform for safety when work is performed on the platform. A ladder 178 is coupled to a rear portion of the frame 102 and platform 108 to allow access to the platform. The sorting area 116 is mounted on the platform 108 towards the center of the platform. The sorting area 116 can include a sorting belt 170 that is configured to carry clams provided by the lifting device 114. Underneath the sorting belt 170 is a plate that can catch any unsorted clams that moves along the sorting belt. The sorting belt 170 is configured to sort clams by size and discard any unwanted materials or clams. The sorting belt 170 can also filter clams of a certain size that is equal to or less than a threshold size and discharge the clams that are too small through a return chute 176. A clam chute (not shown) can be used to move the desired clams to a location away from the clam harvester 100. In one example, the sorting belt 170, plate, and return chute 176 are part of a sorting trough 172. The return chute 176 is configured to return the unwanted clams back to the loosened substrate area previously picked up by the clam harvester 100 so the clams can easily re-burrow and grow to harvestable maturity or such that the clams can be greater than the threshold size and packed in mesh bags or other suitable containment devices.

FIG. 1E illustrates a top view of the example provided in FIG. 1A. In one example, as illustrated in FIG. 1E, the clam harvester 100 includes a frame 102 and a moving mechanism 104 attached to the frame. The frame also includes a front portion 110 and a rear portion 112 such that the front portion 110 supports a clam scoop 106 located at the front portion of the frame. A platform 108 is mounted above the frame and includes a sorting area 116. A lifting device 114 couples the clam scoop 106 with the sorting area 116 on the platform 108. The lifting device 114 moves clams collected by the clam scoop 106 vertically or substantially vertically to the sorting area 116.

In one example, the clam scoop 106 is pivotally mounted to the front portion of the frame 102. In one example, the clam scoop 106 includes a bucket 130 and a connecting assembly that connects the bucket to the frame. The bucket 130 includes a leading edge 131, a base portion 132, a raised portion 134, and two side surfaces 133 mounted between the base portion 132 and raised portion 134. In one example, the base portion 132 can be a planar surface that is generally flat and can be inclined relative to the seafloor. In one example, the raised portion 134 of the bucket has an opening 136 (not shown). In another example, the leading edge 131 of the bucket includes teeth or tines. In another example, the leading edge 131 is a blade. In one example, the base portion also supports a set of water ports and water jets (shown in later figures). The water jets fluidize a substrate on the ground to create a slurry where clams can float to the surface while at least the base portion 132 of the bucket 130 is configured to be underneath the habitat depth of the clams.

In one example, the clam scoop is configured to move from a non-harvesting position to a harvesting position. In the harvesting position, the leading edge 131 of the bucket 130 is submerged underneath a sand bed or mud bed to engage a substrate. When engaged, the leading edge 131 and at least a portion of the base portion 132 of the bucket 130 is configured to be underneath the substrate surface and the clam depth habitat. The clam scoop 130 can be partially submerged into water or fully submerged into water. The frame 102 can also be partially submerged into water to allow the clam scoop 130 to engage a deeper sand bed. In another example, the bucket 130 can be inserted up to three feet (3′) deep into the sand bed. In one example, the clam scoop 106 can move continuously through a sand bed in the harvesting position while the frame 102 is moving continuously with the clam scoop. In other words, the clam scoop 106 can be driven through a substrate by the motorized clam harvesting vehicle.

In one example, the bucket 130 of the clam scoop 106 includes an opening 136 that serves as a gate to a catchment area for any substrate captured. The connection of the clam scoop 106 and frame is configured such that the fluidized slurry can flow from the leading edge 131 of the bucket 130, through the base portion 132, and out of the bucket to the catchment area behind the raised portion 134 of the bucket. In another example, the substrate proceeds through a filtration system and clams can be moved from the bucket through an opening 136 to the filtration system, and then to the lifting device 114 that lifts any clams captured by the bucket to the sorting area 116 of the clam harvester 100.

In another example, the catchment area can also be a filtration system for any substance, clams, or fluidized substrate or slurry. The filtration system includes at least a grate 150 which links the raised portion 134 of the bucket 130 at an opening 136 to the lifting device 114. The grate 150 is configured to further allow the catchment area to filter unwanted substance such as sand or mud so that only a substrate with a substantial amount of clams or only clams can move passed the grate to the lifting device 114.

In another example, the grate 150, which connects the bucket 130 and the lifting device 114, can pivotally move with the bucket so that continuous flow of the substrate from the clam scoop 106, through the grate 150, and to the lifting device 114 is possible regardless of the position of the bucket.

In another example, the clam scoop 106 also includes at least one water pump (shown in later figures) that is configured to wash the substrate as it moves along the grate 150 to separate the unwanted substance and the clams more easily. In another example, the opening 136 can receive a continuous amount of substrate when the clam harvester 100 moves along a sand bed. In another example, the base portion 132 of the bucket 130 can be wider than that of the raised portion 134 to allow for a better continuous flow of the slurry passing through the bucket and to the grate 150. Other examples of the filtration system, including using water jets, are described in detail in other figures.

In one example, the lifting device 114 is a mechanically driven conveyor belt 160 with a plurality of buckets or cleats that catch the clams from the bucket 130 and lifted by the conveyor belt 160 to the platform 108. In one example, the lifting device 114 is a lifting chute, a hopper belt or any other lifting device or motorized lifting device known in the art for loading and unloading products. In another example, the lifting device 114 can be a clam transfer tube. The transfer tube carries the clams collected by the clam scoop 106 vertically or substantially vertically towards the platform 108 using an impeller-less pump. A dewatering pump can be configured at the top of the clam transfer tube to remove water from the clams as the clams move from the transfer tube or impeller-less pump to the sorting area 116.

In one example, the platform 108 spans over the legs 120 of the frame 102. In another example, the platform has a rail 180 surrounding the platform for safety when work is performed on the platform. A ladder 178 is coupled to a rear portion of the frame 102 and platform 108 to allow access to the platform. The sorting area 116 is mounted on the platform 108 towards the center of the platform. The sorting area 116 can include a sorting belt 170 that is configured to carry clams provided by the lifting device 114. In another example, a hole or cutout 109 can be formed in the platform 108 where the lifting device 114 can extend from underneath the platform through the hole and ends at the sorting area 116. Underneath the sorting belt 170 is a plate that can catch any unsorted clams that moves along the sorting belt. The sorting belt 170 is configured to sort clams by size and discard any unwanted materials or clams. The sorting belt 170 can also filter clams of a certain size that is equal to or less than a threshold size and discharge the clams that are too small through a return chute 176. A clam chute (not shown) can be used to move the desired clams to a location away from the clam harvester 100. In one example, the sorting belt 170, plate, and return chute 176 are part of a sorting trough 172. The return chute 176 is configured to return the unwanted clams back to the loosened substrate area previously picked up by the clam harvester 100 so the clams can easily re-burrow and grow to harvestable maturity or such that the clams can be greater than the threshold size and packed in mesh bags or other suitable containment devices.

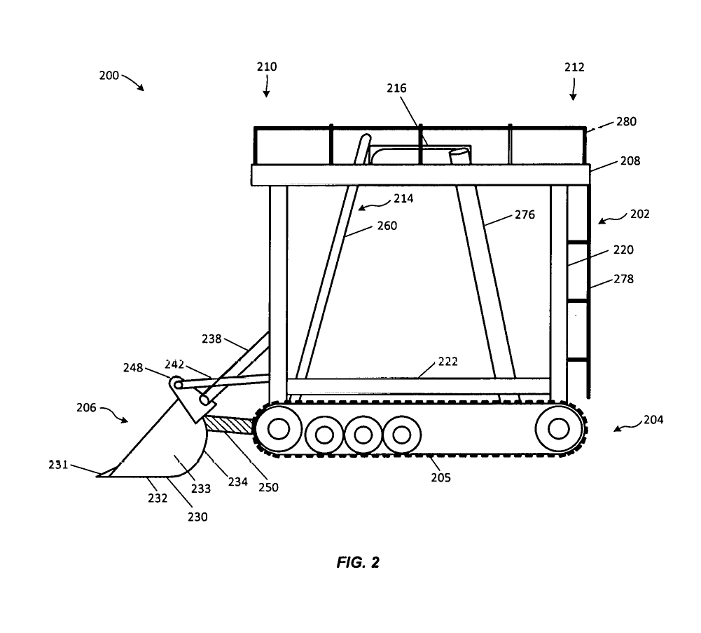

FIG. 2 illustrates an example of a clam harvester 200 (alternatively referred to as a mechanical clam harvester, a clam harvesting device, or a clam harvesting assembly). The clam harvester 200 includes a frame 202 and a moving mechanism 204 attached to the frame. The frame also includes a front portion 210 and a rear portion 212 such that the front portion 210 supports a clam scoop 206 (alternatively referred to as a clam scoop assembly) located at the front portion of the frame. A platform 208 is mounted above the frame and includes a sorting area 216. A lifting device 214 couples the clam scoop 206 with the sorting area 216 on the platform 208. The lifting device 214 moves clams collected by the clam scoop 206 vertically or substantially vertically to the sorting area 216.

In one example, the frame 202 includes a plurality of legs 220 (alternatively referred to as vertical support members) proximate to each of the front portion 210 and rear portion 212 of the frame 202, connected by at least one support beam 222. The legs 220 and at least one support beam 222 form a rectangular shape that supports the platform 208 and clam scoop 206. In another example, the frame includes four legs 220 connected by two support beams 222 and the platform 208 is mounted on top of the four legs.

In one example, the moving mechanism 204 can be a pair of continuous tracks with treads 205 attached to each leg 220 of the frame 202. The continuous tracks can be wider than that of the footprint set by having individual wheels. The continuous tracks can be configured to distribute the total weight of the frame 202 and clam scoop 206 uniformly. In another example, the treads 205 are made of rubber. In another example, each continuous track of the pair of continuous tracks are controlled and driven separately. In one example, the moving mechanism 204 is hydraulically actuated with at least one piston to the frame 202. In another example, wheels of the continuous tracks can be rotated by a motor by a motor or motors configured to drive the wheels. In another example, the wheels can be driven by motors inside of each wheel. In another example, the pair of continuous tracks with treads 205 of the moving mechanism 204 includes wheels that can be driven by electric motors, independently of each other.

In one example, the clam scoop 206 is pivotally mounted to the front portion of the frame 202. In one example, the clam scoop 206 includes a bucket 230 and a connecting assembly that connects the bucket to the frame. The bucket 230 includes a leading edge 231, a base portion 232, a raised portion 234, and two side surfaces 233 mounted between the base portion 232 and raised portion 234. In one example, the base portion 232 can be a planar surface that is generally flat and can be inclined relative to the seafloor. In one example, the raised portion 234 of the bucket has an opening 236 (not shown). In another example, the leading edge 231 of the bucket includes teeth or tines. In another example, the leading edge 231 is a blade. In one example, the base portion also supports a set of water ports and water jets (shown in later figures). The water jets fluidize a substrate on the ground to create a slurry where clams can float to the surface while at least the base portion 232 of the bucket 230 is configured to be underneath the habitat depth of the clams.

In another example, the connecting assembly includes a support axle connected to the front portion 210 of the frame 202 at a pivot axis. The support axle can be coupled to a first end of link arm 238. The bucket 230 is coupled to another end of the link arm 238. In another example, the link arm 238 is pivotally connected to a flat plate 248 that protrude from the side 233 of the bucket 230. In one example, the support axle and link arm 238 can be locked and is configured to not pivot about an axis. In another example, the support axle and link arm 238 can rotate about the pivot axis to allow the bucket to move to various positions. In another example, the support axle and link arm 238 can pivot to allow height adjustment of the bucket 230. The connecting assembly can include a second support axle at a second pivot axis. The second support axle is pivotally coupled to one end of a second link arm or rocker arm 242. The rocker arm 242 can be pivotally connected to flat plate 248. The second support axle and rocker arm 242 can rotate about the second pivot axis to allow the bucket to move to various positions. In another example, the rocker arm 242 can extend beyond the pivot axle. In another example, the connecting assembly of the clam scoop 206 is mounted to the frame 202 with one or more hydraulic arms. In another example, at least one of pivot axle 240 and 244 are coupled to at least one motor that turn the pivot axle or axles and move the bucket 230 from one position to another position. In one example, the clam scoop 206 is mounted to the front portion of the frame 202 with a pair of fixed arms and a pair and hydraulic rotators pivotally connecting the pair of fixed arms and the clam scoop 206.

In one example, the clam scoop is configured to move from a non-harvesting position to a harvesting position. In the harvesting position, the leading edge 231 of the bucket 230 is submerged underneath a sand bed or mud bed to engage a substrate. When engaged, the leading edge 231 and at least a portion of the base portion 232 of the bucket 230 is configured to be underneath the substrate surface and the clam depth habitat. The clam scoop 230 can be partially submerged into water or fully submerged into water. The frame 202 can also be partially submerged into water to allow the clam scoop 230 to engage a deeper sand bed. In another example, the bucket 230 can be inserted up to three feet (3′) deep into the sand bed. In one example, the clam scoop 206 can move continuously through a sand bed in the harvesting position while the frame 202 is moving continuously with the clam scoop. In other words, the clam scoop 206 can be driven through a substrate by the motorized clam harvesting vehicle.

In one example, the bucket 230 of the clam scoop 206 includes an opening 236 that serves as a gate to a catchment area for any substrate captured. The connection of the clam scoop 206 and frame is configured such that the fluidized slurry can flow from the leading edge 231 of the bucket 230, through the base portion 232, and out of the bucket to the catchment area behind the raised portion 234 of the bucket. In another example, the substrate proceeds through a filtration system and clams can be moved from the bucket through an opening 236 to the filtration system, and then to the lifting device 214 that lifts any clams captured by the bucket to the sorting area 216 of the clam harvester 200.

In another example, the catchment area can also be a filtration system for any substance, clams, or fluidized substrate or slurry. The filtration system includes at least a grate 250 which links the raised portion 234 of the bucket 230 at an opening 236 (not shown) to the lifting device 214. The grate 250 is configured to further allow the catchment area to filter unwanted substance such as sand or mud so that only a substrate with a substantial amount of clams or only clams can move passed the grate to the lifting device 214. In another example, the clam scoop 206 also includes at least one water pump (shown in later figures) that is configured to wash the substrate as it moves along the grate 250 to separate the unwanted substance and the clams more easily. Other examples of the filtration system, including using water jets, are described in detail in other figures.

In one example, the lifting device 214 is a mechanically driven conveyor belt 260 with a plurality of buckets or cleats that catch the clams from the bucket 230 and lifted by the conveyor belt 260 to the platform 208. In one example, the lifting device 214 is a lifting chute, a hopper belt or any other lifting device or motorized lifting device known in the art for loading and unloading products. In another example, the lifting device 214 can be a clam transfer tube. The transfer tube carries the clams collected by the clam scoop 206 vertically or substantially vertically towards the platform 208 using an impeller-less pump. A dewatering pump can be configured at the top of the clam transfer tube to remove water from the clams as the clams move from the transfer tube or impeller-less pump to the sorting area 216.

In one example, the platform 208 spans over the legs 220 of the frame 202. In another example, the platform has a rail 280 surrounding the platform for safety when work is performed on the platform. A ladder 278 is coupled to a rear portion of the frame 202 and platform 208 to allow access to the platform. The sorting area 216 is mounted on the platform 208 towards the center of the platform. The sorting area 216 can include a sorting belt 270 that is configured to carry clams provided by the lifting device 214. Underneath the sorting belt 270 is a plate that can catch any unsorted clams that moves along the sorting belt. The sorting belt 270 is configured to sort clams by size and discard any unwanted materials or clams. The sorting belt 270 can also filter clams of a certain size that is equal to or less than a threshold size and discharge the clams that are too small through a return chute 276 (alternatively referred to as a discharge chute). A clam chute (not shown) can be used to move the desired clams to a location away from the clam harvester 200. The return chute 276 is configured to return the unwanted clams back to the loosened substrate area previously picked up by the clam harvester 200 so the clams can easily re-burrow and grow to harvestable maturity or such that the clams can be greater than the threshold size and packed in mesh bags or other suitable containment devices.

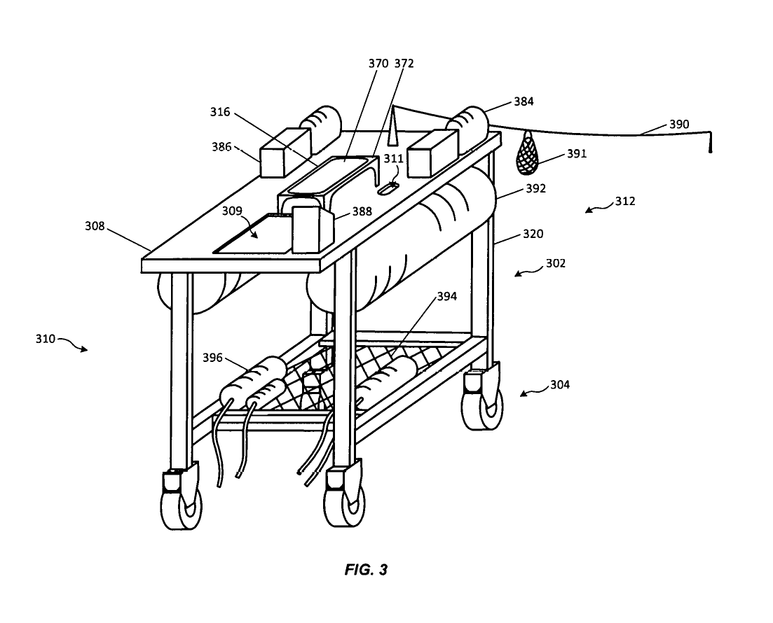

FIG. 3 illustrates an example of a clam harvester 300 (alternatively referred to as a mechanical clam harvester, a clam harvesting device, or a clam harvesting assembly) in a perspective view. For purposes of illustration only, some components of the clam harvester 300 (shown in FIGS. 1A-E) have been removed to simply the drawing so that the drawing can focus on key aspects of the clam harvester 300 that was not shown in the clam harvester illustrated in FIGS. 1A-E. The clam harvester 300, as shown FIG. 3, includes a frame 302 and a moving mechanism 304 attached to the frame. The frame also includes a front portion 310 and a rear portion 312 such that the front portion 310 supports a clam scoop (not shown) located at the front portion of the frame. A platform 308 can be mounted above the frame and includes a sorting area 316. A lifting device (not shown) couples the clam scoop with the sorting area 316 on the platform 308.

In one example, the frame 302 includes a plurality of legs 320 (alternatively referred to as vertical support members) proximate to each of the front portion 310 and rear portion 312 of the frame 302, connected by at least one support beam 322. The legs 320 and at least one support beam 322 form a rectangular shape that supports the platform 308 and clam scoop 306. In another example, the frame includes four legs 320 connected by two support beams 322, where the platform 308 can be mounted on top of the four legs 320.

In one example, the moving mechanism 304 can be a set of wheels that can be attached to each leg 320 of the frame 302. In one example, the wheels can be casters. The wheels can be mechanically connected to each other by an axle or axles or individually mounted independent of each other. In another example, the wheels can swivel casters wherein each caster can move on a surface in any direction independent of any of the other casters. In another example, the moving mechanism 304 can be hydraulically actuated with at least one piston to the frame 302. In another example, the wheels can be rotated by a motor (or motors) configured to drive the wheels. In another example, the wheels can be driven by motors inside of each wheel. In another example, the wheels turn by a hydraulic turning system and move by a hydraulic driveshaft. In another example, the moving mechanism 304 includes wheels that have 4-wheel electric drive. In another example, the moving mechanism 304 includes wheels that can be driven by electric motors, independently of each other. In another example, a steering system drives and steers the clam harvester 300. In another example, the wheels include mud or sand tires or any tires with treads.

In one example, the platform 308 spans over the legs 320 of the frame 302. The sorting area 316 can be mounted on the platform 308 towards the center of the platform. The sorting area 316 can include a sorting belt 370 that is configured to carry clams provided by the lifting device 314. In another example, a hole or cutout 309 can be formed in the platform 308 where the lifting device can extend from underneath the platform through the hole and ends at the sorting area 316. Underneath the sorting belt 370 can be a plate that can catch any unsorted clams that move along the sorting belt. The sorting belt 370 can be configured to sort clams by size and discard any unwanted materials or clams. The sorting belt 370 can also filter clams of a certain size that the clams can be equal to or less than a threshold size and discharge the clams that are too small through a return chute 376 (alternatively referred to as a discharge chute). A portion of the platform 308 can be configured to be a physical sorting area where a person can stand or sit on the platform and manually sort clams along the sorting belt 370. In another example, at least a portion of the platform is configured to be a collection area for manually packing the sorted clams. The clams that are desired and sorted from the sorting belt 370 can be packed in a mesh bag 391 or other suitable containing devices which can be secured onto a longline 390 that is anchored and buoyed, back into the water where the clams can be held live and retrieved from the water at a future time by a surface vessel and transported to a location for relocation or processing.

The platform 308 can also include a discard hole 311 that can be connected to a separate chute. Some of the collected clams will be rejected, for example because they do not meet a minimum size requirement, or because they fail to meet a quality requirement. Such clams can be shunted through the discard hold 311, through the separate chute, and then returned back onto the sea floor.

In some aspects, the platform 308 can also support fuel tanks 384 (alternatively referred to as gas tanks) that can hold fuel for engines 386 or other motors on the clam harvester 300. The engines 386 can be mechanically coupled to portions of the clam harvester in order to drive, for example, wheels, treads, a clam scoop, a conveyor belt, or a combination thereof.

A clam chute (not shown) can be used to move the desired clams to a location away from the clam harvester 300. In one example, the sorting belt 370, plate, and return chute 376 are part of a sorting trough 372. The return chute 376 can return the unwanted clams back to the loosened substrate area previously picked up by the clam harvester 300 so the clams can easily re-burrow and grow to harvestable maturity or such that the clams can be greater than the threshold size and packed in mesh bags or other suitable containment devices.

In one example, the clam harvester 300 can be configured to move from a non-harvesting position to a harvesting position. In the harvesting position, the clam scoop can engage a substrate of sand or mud in a sand bed or mud bed by submerging underneath the sand bed or mud bed. The clam scoop of the clam harvester 300 can be partially submerged into water or fully submerged into water. The frame 302 can also be partially submerged into water to allow the clam scoop 330 to engage a deeper sand bed. In another example, a bucket of the clam scoop can be inserted up to three feet (3′) deep into the sand bed. The clam scoop 306 can move continuously through a sand bed in the harvesting position while the frame 302 can be moving continuously with the clam scoop 306. In other words, the clam scoop 306 can be driven through a substrate by the motorized clam harvesting vehicle.

In one example, one or more air chutes 392 can be disposed underneath the platform 308 and are configured to subject the platform of the lifting device 300 above water such that the depth of the water can be greater than that of the height of the lifting device. As the clam scoop is configured in the harvesting position and is engaged in the substrate, the air chutes 392 can protect the platform 308 and elements disposed above the platform from being submerged in water when the depth of the water is greater than that of the height of the lifting device. The air chutes 392 can also protect the platform 308 and elements disposed above the platform from sinking into the sand bed if the sand bed is too soft or viscous such that the frame 302 of the clam harvester 300 sinks into the sand bed. In another example, the one or more air chutes 392 can be used as a flotation device so that when the clam harvester 300 is disposed in water deeper than that of the height of the clam harvester 300, the clam harvester 300 can be towed from one area to another area on water.

In one example, a plurality of support beams connected to the legs 320 of the clam harvester 300 can support a net 394. The net 394 can support removable materials such as tools, other smaller air chutes 396, or packaged clams.

In one example, a control unit 388 can be disposed on the platform for controlling the movement of the clam scoop's harvesting and non-harvesting positions and the movement of the clam harvester 300.

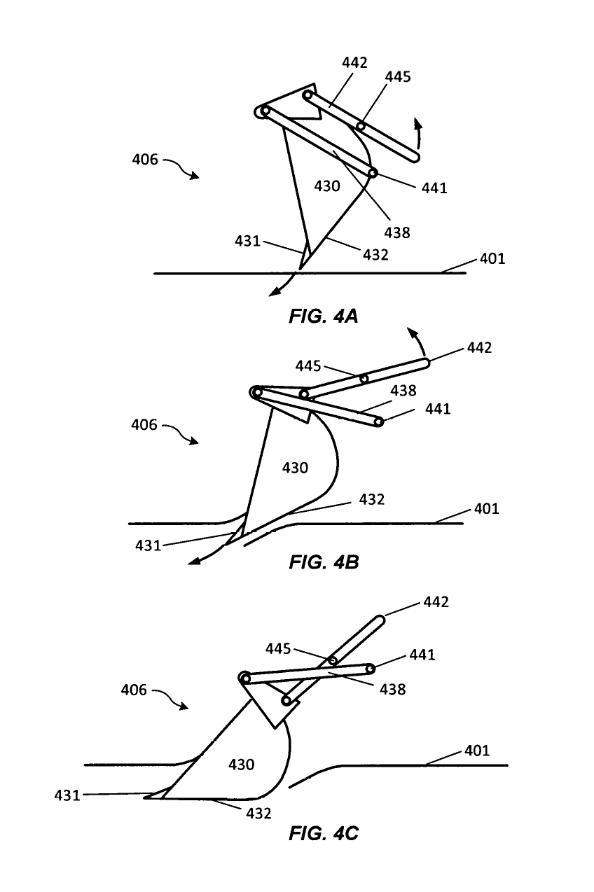

FIGS. 4A-4C illustrate an example side view of a clam scoop 406 as the clam scoop 406 moves from a non-harvesting position to a harvesting position of soft shell clams.

In one example, the clam scoop 406 can be pivotally mounted to a front portion of the frame of the clam harvester. In another example, the clam scoop 406 includes a bucket 430 and a connecting assembly that connects the bucket to the frame. The bucket 430 includes a leading edge 431, a base portion 432, a raised portion, and two side surfaces. In one example, the base portion 432 can be a planar surface that is generally flat and can be inclined relative to the seafloor.

In one example, the clam scoop 406 includes a connecting assembly that allows the bucket 430 to move from a harvesting position to a non-harvesting position. The connecting assembly can include a pair of rocker arms 438 and a second pair of rocker arms 442. The bucket 430 is coupled to one end of each pair of rocker arms 438 and pair of rocker arms 442. The frame (not shown) of the clam harvester is couple to the other end of each pair of rocker arms 438 and pair of rocker arms 442. The pair of rocker arms 438 can rotate about an axis 441 and the pair of rocker arms 442 can rotate about an axis 445. The rotation of the rocker arms 438 and 442 about the axis 441 and 445, respectively, allows height adjustment of the bucket 430. In another example, the rotation of the rocker arms 438 and 442 about the axis 441 and 445, respectively, allows the bucket 430 to move from an inclined position relative to a sand bed 401 to a flat or parallel position relative to the sand bed 401 such that the bucket can collect the substrate including sand and soft shell clams.

As shown in FIGS. 4A-4C, the leading edge 431 of the bucket 430 can engage a substrate of sand or mud in the sand bed 401 by submerging underneath the sand bed or mud bed. When engaged, the leading edge 431 and at least a portion of the base portion 432 of the bucket 430 is configured to be underneath the substrate surface and the soft shell clam depth habitat. The bucket 430 can be partially submerged into water or fully submerged into water. In another example, as shown in FIG. 4C., the bucket 430 can be partially submerged into the sand bed 401. The bucket 430 can be inserted up to three feet (3′) deep into the sand bed 401. In one example, the clam scoop 406 can move continuously through a sand bed in the harvesting position while the clam harvester can be moving continuously with the clam scoop 406. In other words, the clam scoop 406 can be driven through a substrate by the motorized clam harvesting vehicle.

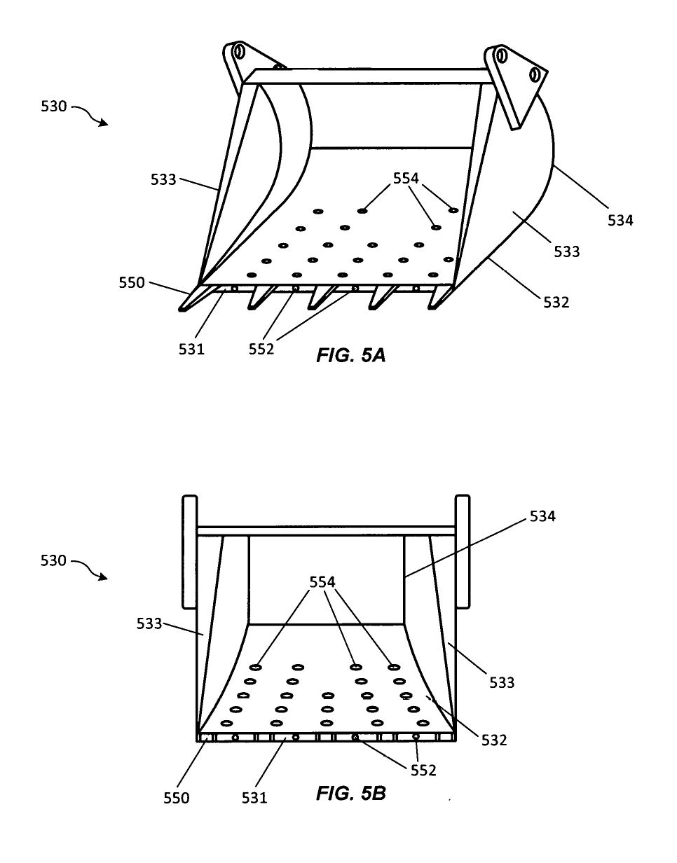

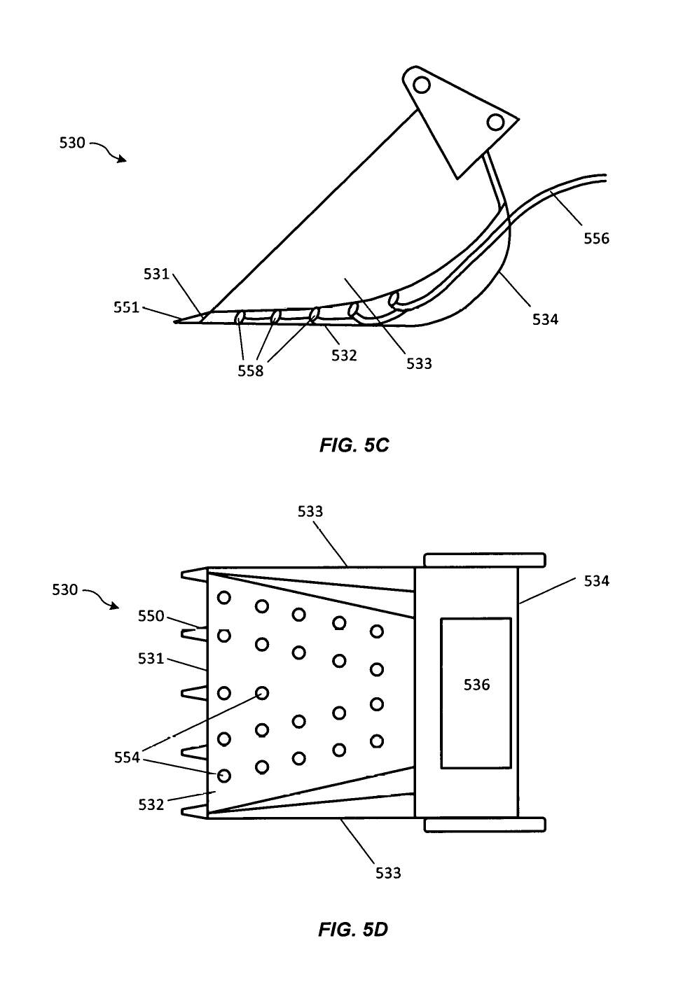

FIGS. 5A-5D illustrate different views of an example clam scoop or harvesting tool for harvesting soft shell clams. The clam scoop can include a bucket 530 that can support water jets 558 (shown in FIG. 5C) configured to fluidize a substrate of sand in a sand bed.

In one example, as shown in FIGS. 5A-5B, illustrating a perspective view and front view, the bucket 530 includes a leading edge 531, a base portion 532, a raised portion 534 (alternatively referred to as a rear portion or an inclined portion), and two side surfaces 533 mounted between the base portion 532 and raised portion 534. In one example, the base portion 532 can be a planar surface that is generally flat and can be inclined relative to the seafloor. In one example, the leading edge 531 of the bucket 530 can engage a substrate of sand or mud in a sand bed or mud bed by submerging underneath the sand bed or mud bed. When engaged, the leading edge 531 and at least a portion of the base portion 532 of the bucket 530 is configured to be underneath the substrate surface and the soft shell clam depth habitat. In another example, the bucket 530 can be inserted up to three feet (3′) deep into the sand bed. In another example, the leading edge 531 of the bucket includes teeth 550 such that the leading edge 531 of the clam scoop 530 can better engage the sand bed as the clam scoop 530 engages the sand bed. In another example, the leading edge 531 can be a blade.

In one example, the leading edge 531 of the bucket 530 includes a plurality of forward water ports 552 configured to be an outlet of the water jets 558. When the clam scoop prepares to move from a non-harvesting position to a harvesting position, the water jets 558 are configured to eject water at a rate sufficient to fluidize the substrate of sand where softshell clams are located. The water jets 558 pump pressurized water into the substrate of sand to create a slurry where clams can float generally near the surface of the slurry. The slurry is also more easily penetrable by the bucket 530. As the bucket engages the slurry containing sand, water, and soft shell clams, the slurry slides above the base portion 532 of the bucket 530 such that the base portion 532 is configured to be underneath the habitat depth of the soft shell clams.

In one example, the base portion 532 supports a plurality of upward water ports 554 configured to be an outlet of the water jets 558. As the slurry slides above the base portion 532. In one configuration, the clam harvester moves continuously along the sand bed such that a continuous amount of substrate of the sand bed containing sand and soft shell clams is turned into slurries from the water jets 558 spraying out of the forward water ports 552 of the leading edge 531. As the slurry continuously moves from a front portion of the base portion 532 to a rear portion of the base portion 532, secured by the side surfaces 533, and out of an opening 536 (shown in FIG. 5D), the water jets 558 at upward water ports 554 spray pressurized water upwards. The pressurized water spraying upwards from the base portion 532 can either turn substrate collected by the bucket 530 into a slurry or further turn the slurry formed from the pressurized water spraying form the leading edge collected by the bucket 530 into a more viscous slurry. As the more viscous slurry of softshell clams continuously move towards the raised portion 534 of the bucket 530, the slurry exits the bucket 530 through the opening 536 and flows onto a catchment area. In one example, the continuous movement of the slurry, as the slurry slides through the bucket 530, will be relative to the movement of the clam harvester moving in the opposite direction.

In one example, as shown in FIG. 5C, illustrating a side view of the bucket 530, the water jets 558 are connected to a water lines 556. In another example, the water jets 558 share a common set of water lines 556. In another example, the water jets 558 are driven by a low-pressure high-volume water pump. In another example, the water pump is configured so that both the pressure and volume of water can be adjusted. In another example, a first water pump drives the water jets 558 that sprays water out of the forward water ports 552 of the leading edge 531 of the bucket 530. In another example, a second water pump drives the water jets 558 that sprays water out of the upward water ports 554 of the base portion 532 of the bucket 530. In another example, the water pump or water pumps are mounted at the raised portion 534 of the bucket 530. In another example, the water pump or water pumps are mounted on a frame supporting the clam scoop of the clam harvester.

In one example, as shown in FIG. 5D, illustrating a top view of the bucket 530, the two side surfaces 533 mounted between the base portion 532 and raised portion 534, are angled relative to each other such that as physically guide the more viscous slurry of softshell clams continuously towards the raised portion 534 of the bucket 530 and exits the bucket 530 through the opening 536. In one example, the continuous movement of the slurry, as the slurry slides through the bucket 530, will be relative to the movement of the clam harvester moving in the opposite direction. In other words, the angled portions of the side surfaces 533 that form the scoop aid in the ability of the bucket 530 to dig through a substrate.

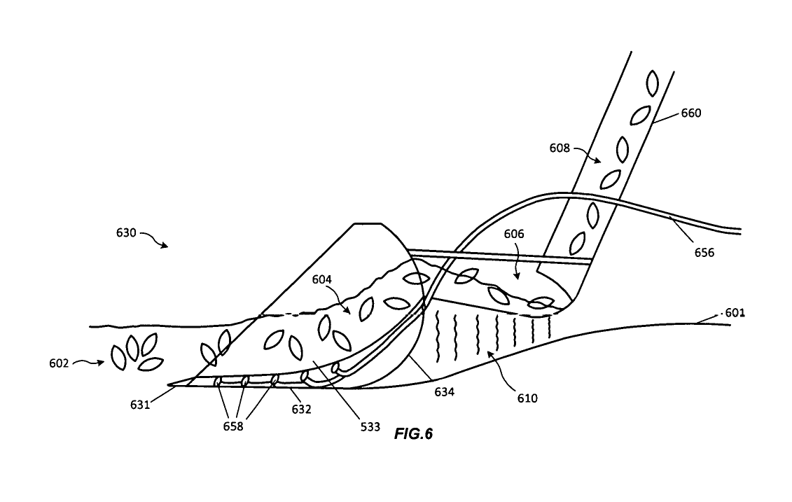

FIG. 6 illustrates an example clam scoop for harvesting soft shell clams. The clam scoop can include a bucket 630 that can support water jets 658 configured to fluidize a substrate 602 of sand and softshell clams in a sand bed 601, a catchment area configured to receive a fluidized substrate 604 and separate or filter soft shell clams from sand of the substrate 602, and a lifting device 660 configured to receive filtered soft shall clams 608 and transport the filtered soft shell clams 608 to a sorting area.

In one example, the bucket 630 includes a leading edge 631, a base portion 632, a raised portion 634 (alternatively referred to as a rear portion or an inclined portion), and two side surfaces 633 mounted between the base portion 632 and raised portion 634. In one example, the base portion 632 can be a planar surface that is generally flat and can be inclined relative to the seafloor when preparing to engage with the seafloor and parallel to the seafloor when engaged with the seafloor. In one example, the leading edge 631 of the bucket 630 can engage a substrate of sand or mud in a sand bed or mud bed by submerging underneath the sand bed or mud bed. When engaged, the leading edge 631 and at least a portion of the base portion 632 of the bucket 630 is configured to be underneath the substrate surface and the soft shell clam depth habitat. In another example, the bucket 630 can be inserted up to three feet (3′) deep into the sand bed. In another example, the leading edge 631 can be a blade.

In one example, the base portion 632 supports a plurality of water ports to support water jets 658. As the substrate 602 is collected by the bucket 630, the water jets 558 spray the substrate and turn the substrate into a fluidized substrate 604. In one example, the fluidized substrate is a slurry including sand, softshell clams, and water. In one configuration, the clam harvester moves continuously along the sand bed such that a continuous amount of substrate 602 is collected by the bucket 630. As the substrate continuously moves from a front portion of the base portion 632 to a rear portion of the base portion 632, secured by the side surfaces 633, the water jets 658 spray pressurized water upwards. The pressurized water spraying upwards from the base portion 632 can turn the substrate 630 collected by the bucket 630 into a fluidized substrate 604. As the fluidized substrate exits the bucket 630 through an opening and flows onto a catchment area, the fluidized substrate 604 can be further washed by a separate set of water jets, driven by a water pump, to return a fluidized sand 610 of the fluidized substrate 604 back onto the seafloor. In one example, the remaining filtered soft shell clams 608 will enter the lifting device 660 and sent to the sorting area.

In one example, the water jets 658 are connected to a water lines 656. In another example, the water jets 658 are driven by a low-pressure high-volume water pump. In another example, the water pump is configured so that both the pressure and volume of water can be adjusted. In another example, the water pump or water pumps are mounted at the raised portion 634 of the bucket 630. In another example, the water pump or water pumps are mounted on a frame supporting the clam scoop of the clam harvester. In another example, the pump is configured to recycle water.

As used herein, the singular forms “a”, “an”, and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

While the above description describes various embodiments of the invention and the best mode contemplated, regardless how detailed the above text, the invention can be practiced in many ways. Details of the system may vary considerably in its specific implementation, while still being encompassed by the present disclosure. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

The teachings of the invention provided herein can be applied to other systems, not necessarily the system described above. The elements and acts of the various examples described above can be combined to provide further implementations of the invention. Some alternative implementations of the invention may include not only additional elements to those implementations noted above, but also may include fewer elements. Further any specific numbers noted herein are only examples; alternative implementations may employ differing values or ranges, and can accommodate various increments and gradients of values within and at the boundaries of such ranges

References throughout the foregoing description to features, advantages, or similar language do not imply that all of the features and advantages that may be realized with the present technology should be or are in any single embodiment of the invention. Rather, language referring to the features and advantages is understood to mean that a specific feature, advantage, or characteristic described in connection with an embodiment is included in at least one embodiment of the present technology. Thus, discussion of the features and advantages, and similar language, throughout this specification may, but do not necessarily, refer to the same embodiment. Furthermore, the described features, advantages, and characteristics of the present technology may be combined in any suitable manner in one or more embodiments. One skilled in the relevant art will recognize that the present technology can be practiced without one or more of the specific features or advantages of a particular embodiment. In other instances, additional features and advantages may be recognized in certain embodiments that may not be present in all embodiments of the present technology.

What is claimed is:

1. A method for harvesting soft-shelled clams, comprising:
moving a scoop from a first position to a second position, wherein moving the scoop from the first position to the second position inserts the scoop into a substrate, wherein the substrate contains one or more clams, and wherein the scoop is pivotally mounted to a front of a frame;
spraying water into the substrate using a plurality of water jets, wherein the scoop includes a first set of water ports on a surface of the scoop, wherein a portion of the plurality of water jets spray water into the substrate through the first set of water ports while the scoop is underneath the substrate, and wherein spraying the water loosens the substrate;
driving the scoop through the loosened substrate, such that the one or more clams in the loosened substrate enter a catchment area behind the scoop; and
transporting the one or more clams from the catchment area to a collection area mounted to the frame, wherein the one or more clams are transported using a conveyer belt.

2. The method of claim 1, wherein water is driven through the plurality of water jets by one or more of a water pump, a recycling water pump, pressurized air, or a combination thereof.

3. The method of claim 1, wherein the scoop includes a second set of water ports along a leading edge of the scoop, wherein a portion of the plurality of water jets spray water through the second set of water ports from the leading edge of the scoop, thereby aiding the scoop in entering the sand when the scoop is inserted into the substrate.

4. The method of claim 3, wherein the set of jets pushing water through the first set of water ports is driven by a first pump and the set of jets pushing water through the second set of water ports is driven by a second pump, or wherein the set of jets pushing water through the first set of water ports and the second set of water port are is driven by a single pump.

5. The method of claim 1, wherein the scoop can be inserted up to three feet deep into the substrate.

6. The method of claim 1, further comprising:
separating loosened substrate and the one or more clams in the catchment area using a second set of water jets, wherein the catchment area includes a grate through which the loosened substrate can flow, and wherein the collection area includes a clam sorter configured to sort clams by size.

7. The method of claim 1, further comprising:
sorting, using a clam sorter, the one or more clams by size, wherein the clam sorter deposits clams less than or equal to a threshold size in a first container, and wherein the clam sorter deposits clams greater than the threshold size in a second container;
storing a set of clams from the one or more clams in a storage container;
securing the storage container to an anchor, wherein the anchor maintains a position of the storage container, and wherein the position is submerged; and
returning a set of clams from the one or more clams to the substrate, wherein the returning the set of clams includes using a chute mounted to the frame.

8. A clam harvesting device for harvesting soft-shelled clams, comprising:
a frame;
a scoop pivotally mounted to a front of the frame, wherein the scoop is configured to move from a first position to a second position, wherein the scoop from the first position to the second position inserts the scoop into a substrate, and wherein the substrate contains one or more clams;
a first set of water jets on a surface of the scoop, wherein the first set of water jets are configured to spay water into the substrate while the scoop is underneath the substrate, and wherein spraying the water loosens the substrate;
a catchment area behind the scoop, wherein moving the scoop causes the loosened substrate and the one or more clams in the loosened substrate to enter the catchment area;
a collection area; and
a conveyer belt configured to transport the one or more clams form the catchment area to the collection area.

9. The clam harvesting device of claim 8, further comprising a pump configured to drive the first set of water jets, wherein the pump is configured to recycle water, and wherein pressurized air is used to drive the first set of water jets.

10. The clam harvesting device of claim 8, wherein the scoop includes a second set of water jets along a leading edge of the scoop, wherein the second of water jets assist the leading edge of the scoop in entering the sand when the scoop is inserted into the substrate, and the clam harvesting device further comprises:
a first pump configured to drive the first set of jets and a second pump configured to drive the second set of jets; or
a single pump configured to drive the first set of jets and the second set of jets.

11. The clam harvesting device of claim 8, wherein the scoop is pivotably mounted to the frame using one or more hydraulic arms, wherein, when the scoop is in the first position, the scoop is out of the substrate, and when the scoop is in the second position, the scoop is underneath the substrate, and wherein a mount point of the scoop can be raised or lowered to raise or lower a height of the scoop.

12. The clam harvesting device of claim 8 further comprising:
a second set of water jets configured to separate the loosened substrate and the one or more clams in the catchment area, wherein the catchment area further includes a grate through which the loosened substrate can flow; and
a clam sorter configured to sort clams by size, wherein the clam sorter deposits clams less than or equal to a threshold size in a first container, and wherein the clam sorter deposits clams greater than the threshold size in a second container.

13. The clam harvesting device of claim 8, further comprising:
a chute mounted to the frame, wherein the chute is configured to return clams to the substrate, wherein the frame includes vertical support members and a platform mounted on top of the vertical support members, wherein the collection area is on the platform, and wherein the collection area includes a storage container for storing the one or more clams

14. The clam harvesting device of claim 8, wherein the frame is configured to be partially submerged, wherein the frame is partially submerged when the scoop is inserted into the substrate, and wherein the clam harvesting device further comprises:
a floatation tank mounted to the frame; and
an outboard propulsion device.

15. A scoop for harvesting soft-shell clams, comprising:
a leading edge configured to be inserted into a substrate;
an upper surface located adjacent to the leading edge;
a first set of water jets mounted to the upper surface, wherein the first set of water jets are configured to spray water into the substrate when the scoop is underneath the substrate; and
a rear surface located adjacent to the upper surface, wherein the rear surface includes a mounting point for pivotally mounting the scoop to one or more arms.

16. The scoop of claim 15, further comprising:
a second set of water jets mounted to the leading edge, wherein the second set of jets assist the leading edge in entering the substrate when the scoop is inserted into the substrate.

17. The scoop of claim 15, wherein the leading edge includes teeth.

18. The scoop of claim 15, further comprising:
a first side surface mounted between the upper surface and the rear surface; and
a second side surface mounted between the upper surface and the rear surface opposite to the first side surface, wherein the first side surface and the second side surface each include an upper edge configured to assist the scoop in entering the substrate when the scoop is inserted into the substrate.

19. The scoop of claim 15, wherein the first set of water jet are configured to liquefy the substrate

20. The scoop of claim 15, wherein the scoop is configured to be inserted into sand up to three feet deep and is further configured for digging into wet sand.
